(19) United States
(12) Patent Application Publication
(10) Pub. No.: US 2022/0060449 A1
(43) Pub. Date: Feb. 24, 2022

(54) SYSTEM AND METHOD FOR MONITORING AND SECURING COMMUNICATIONS NETWORKS AND ASSOCIATED DEVICES

(71) Applicant: Intrusion, Inc., Richardson, TX (US)

(72) Inventors: Tommy Joe Head, JR., Hebron, TX (US); Daris Nevil, Springtown, TX (US); Jeremy Hamlyn, Adelaide (AU); Blake Dumas, Allen, TX (US); Lauren Head, Hebron, TX (US)

(21) Appl. No.: 17/405,408

(22) Filed: Aug. 18, 2021

Related U.S. Application Data
(60) Provisional application No. 63/177,818, filed on Apr. 21, 2021.
(60) Provisional application No. 63/068,148, filed on Aug. 20, 2020.

(51) Int. Cl. H04L 29/06; H04L 29/12; H04L 12/46

(52) U.S. Cl. CPC H04L 63/0272; H04L 61/10; H04L 63/1466; H04L 12/4633; H04L 63/029; H04L 12/4641

(57) ABSTRACT

A system and method for shielding a network from malicious or unauthorized activity includes an active monitoring device connected to the network for monitoring each data packet and controlling the network connection. End devices connected to the network are isolated from each other so that data cannot flow in the event one or more data packets, devices, and so on, are flagged as untrustworthy. The active monitoring device uses the filter data to determine whether unusual behavior, unauthorized access, attempted hacking occurred, and ensure isolation between network devices and prevent transfer of data. Continuous monitoring ensures once trusted devices that abnormally change behavior are flagged as untrusted, thereby preventing breaches of the network.

### CROSS-REFERENCE TO RELATED APPLICATION

This application claims priority to U.S. Provisional Application No. 63/068,148 filed on Aug. 20, 2020, and U.S. Provisional Application No. 63/177,818, filed on Apr. 21, 2021, which of which is entirely incorporated herein by reference.

### BACKGROUND

Current network security models are grossly inadequate for ensuring complete immunity from security breaches. Companies and governments have gone through many paths and invested heavily in technology and people. However, the severity of breaches have steadily increased due to the ever-increasing sophistication of viruses, malware, ransomware, spyware, and the like, as well as the ever-increasing knowledge and skill level of persons, entities, and organizations that develop and deploy such devastating tactics for nefarious or other purposes. The security measures of current communications networks and the devices connected thereto can be reduced to a couple of simplified steps including: 1) learning and patching all vulnerabilities; and 2) erecting barriers between the inside and outside (or between trusted and untrusted) devices and networks. The barriers create network enclaves where a section of a network is subdivided from the rest of the network. There are variations on the theme of the enclave model. For example, the conventional physical enclave is replaced by a virtual enclave where, instead of trusting every computer within a network, all trust is based on cryptographic authentication—so a laptop is treated with the same trust whether used within the restrictive physical confines of corporate headquarters or on an unrestricted public WiFi in a hotel, Internet cafe, and the like, or in a foreign country.

However, serious and devastating data breaches can still occur with cryptographic authentication as this technology is based on trust, and changes in trust caused by compromise can occur rapidly. Ransomware's current blatant successes against businesses and governments is based in large part on the firewall and enclave models of the world. Once an adversary is inside the trusted enclave (e.g., being identified as trustworthy), it can laterally spread within that enclave with little to no monitoring, as the adversary has been determined that it can be trusted. Accordingly, large breaches behind the enclave can occur without being noticed perhaps for days, weeks, or even months after the breach and theft of trade secrets and other private data, creating detrimental effects to the compromised company or government, as well as its customers or citizens.

Networking and security initially rest on two underlying transport layers of the Open Systems Interconnection (OSI) model, both of which are insufficient from a security standpoint: Layer 2 bridging (data link layer) and Layer 3 routing (network layer). Layer 2 switches are the physical layer on which the vast majority of devices are networked. For example, with Ethernet switches—any two devices on the same network talk to each other directly through the switch. At Layer 3 (network layer), the network is subdivided into IP subnetworks in which any two devices on the same IP subnetwork talk directly with each other whereas devices on different IP subnetworks use one or more routers to relay their traffic. However, inside a physical or virtual enclave (e.g. through VPN, VLAN, firewall, network access control, etc.), the above-mentioned traffic never passes through a firewall and is treated as internal, trusted communications. This not only invites disaster but has become the root cause of failures for many companies. If a single connected device within the entire corporate infrastructure becomes compromised, is purpose-built (purposely compromised at the place of manufacture to act as a trusted device inside the company's enclave), or is modified in the distribution network to act as a back door into the company's enclave, then essentially nothing stands in the way of this device compromising additional nodes. This is because the compromised or purpose-built device can spoof its way into accessing all of the corporate confidential information, including trade secrets, product development information, customer and vendor information, and the like, by acting like an authenticated device. Internet of Things (IoT) devices make the security problem even harder to spot, as they may be placed inside of a physical or virtual enclave. Thus, any device within a physical or virtual enclave may be the proverbial chink in the security armor when compromised or purpose-built, and defeats the purpose of the expensive and sophisticated network security systems.

Additionally, platforms and devices connect Local Area Networks (LANs) include switches, hubs, and routers. Many smart switches have been developed over the years, with the higher quality units employing variants of Simple Network Management Protocol (SNMP) or Remote Monitoring Network (RMON), which make packet and byte counts between IP pairs visible. However, this visibility is insufficient from a security standpoint as it lacks the necessary depth to monitor and discover spoofing of a Mac Address or IP address (e.g., data packets sent from a potential intruder may be disguised to fake a trusted host). The SNMP and RMON variants are also deficient when it comes to other intruding protocols, such as color changes, e.g. from blue to red, where “blue” represents friendly forces and “red” represents enemy forces. When a device is compromised, it automatically changes roles from “friend” to “adversary”, not merely from an attack defense, but such solutions can be compromised by intruders pretending to be friendly while stealing data, credentials, knowledge, etc., without restraint since the intruders are falsely labeled “blue” and therefore falsely trusted. Other intruding protocols include masquerading, false flags, scans, probes, connections, logins and attempted logins, breaches, breach attempts, unexpected behavior, internal theft of data including user names, passwords, emails, etc., as well as many other types of behavior that cannot be detected by such SNMP or RMON variants. Although it is the object of virtually all companies, governments, and private entities to prevent or stop the outflow of trade secrets and other intellectual property, vendor information and customer data, the monitoring algorithms and hardware that have been included in a switch have been inadequate to ensure the security of the devices connected to the LAN and ultimately the internet.

The existing network monitoring and security solutions may expose themselves to “man-in-the-middle” (MiTM) attack for local to Wide Area Network (WAN) traffic. MiTM attacks occur when an unauthorized entity places itself between two devices or systems in communication with each other, i.e. data transfer occurring from one end point to another, such as one computer to another, one server to another, between a smart phone and server, etc., is intercepted and/or tampered by an attacker. Typically, MiTM attacks are carried out using four different methods, including packet sniffing, packet injection, session hijacking, and SSL stripping. In any event, the MiTM can be likened to a phone line being “bugged” or, in more general terms, one person overhearing a private conversation between two other persons who believe their conversation is private. Second, because of its relative ease in deployment, such a device can become a threat because it can be manipulated to relay some or all traffic through itself. Once it has achieved “man-in-the-middle” status, it can modify, delete, insert, or spoof any traffic it desires, which is known as misattribution, since it appears that the modified or inserted data packets in a traffic stream came from the trusted node rather than the “man-in-the-middle” attack.

Moreover, current network security solutions may have drawbacks, including blindness to spoofing and blindly trusting attackers, thereby unknowingly permitting an adversary to bypass the security controls using different attack protocols such that the monitor cannot see the communications and connections that an adversary wishes to hide. In addition, two computers on the same Layer 2 switched segment, for example, can merely talk to each other directly via bridging or via the use of an overlay IP network other than the primary network, thereby bypassing the monitoring network. Also, if a user chooses to spoof another, the monitor system doesn't always have visibility as to which port on which switch decided to connect using the stolen credentials from another device.

### SUMMARY OF THE INVENTION

Conventional solution of monitoring of networks may include the use of Address Resolution Protocol (ARP) spoofing, Dynamic Host Configuration Protocol (DHCP) reconfiguring, or port mirroring, so that all devices use the monitor as the default gateway. In this manner, all traffic on all ports are redirected to a monitor. However, these monitoring solutions can also be ineffective, as there is no provision for the monitor to guarantee the source device. With spoofing for example, the monitor may be fooled into believing the data came from a trusted source, when in fact it may have come from an unknown source (e.g., an adversary). Additionally, compromised hosts will typically ignore such redirections and communicate directly, thus bypassing the monitor.

The above-mentioned ARP (and later DHCP) solution has been used to insert a one-armed bridge or router into external communications from an enclave. In the ARP spoofing solution, the one-armed bridge or equivalent device essentially races to answer all ARP questions to and from the internet gateway with “that's me” such that all local communications pass through the device. The limitation of this approach is that of compatibility and coverage. To win the race, the audit device (e.g., monitor) may be required to answer before any other device answers an ARP. Otherwise, the audit device may be bypassed and see/hear nothing from a communication. There are also compatibility issues, where some devices can't be spoofed with spoofed ARP responses. Such solution is inexpensive and gains much visibility between local users and the internet, but not all devices will respond to a spoofed ARP reply. Accordingly, such one-armed bridge or router solution cannot monitor everything and can be easily bypassed by adversaries. Additionally, such type of mode is not capable of protecting computers within an enclave from each other or monitoring peer-to-peer communications within an enclave. Thus, these one-armed bridges or routers are used as an insert between the inside and outside of a small network, in much the same manner as a firewall. The aforementioned ARP solution is voluntary instead of mandatory in that it utilizes a race that the one-armed device may or may not win. Therefore, any compromised device can be programmed to bypass the audit device and communicate directly with potential new victims as well as covert communications with pre-compromised devices around a network.

In the DHCP solution mode, a user is required to disable their corporate DHCP servers so that the network is migrated to an overlay IP network which rides on top of their former infrastructure. The DHCP solution mode overcomes some of the limitations of ARP spoofing mode but suffers from some of the same problems. For instance, many devices on a network are configured with static IP addresses, therefore DHCP mode cannot be used to cause these nodes to participate by picking up the alternate router's IP address from DHCP. Therefore, the DHCP mode may require radical restructuring of an enterprise's IP structure such as insertion of a proxy or firewall in an enterprise network which is not practical or secure.

With prior art modern switches, it is possible to mirror traffic from ports in both the inbound and outbound directions into an aggregate feed for analysis by an external monitoring device. However, the aggregate bandwidth of all of the ports usually being higher than any port where monitoring could be placed. The problem is compounded by of loss of fidelity at the port level, i.e. the external monitoring device does not know for sure where any particular packet came from. There are many sub-levels: points and counterpoints along this path. Modern switches have Media Access Control (MAC) address to port mapping and can report which MAC address is on which port, and most modern switches make this query available via Simple Network Management Protocol (SNMP). However, the aggregate maximum number of MAC addresses on a switch is limited by a hardware limitation of the Content Addressable Memory (CAM) built into the hardware. Initially, many were 4096 MAC addresses per network, and now these have been upgraded to 16k MAC addresses per switch. That would then allow a manager to surmise that since MAC address 0000521e4b17 was only seen on port 14 and the network port, for example, that this traffic came from port 14 based on comparing the packet decoded to the MAC to port table in the switch. The counterpoint is that coordinating data from one source via SNMP (or a proprietary switch management interface) and merging that with sensor observations is not optimum and even if implemented, is subject to error. Accordingly, one of the greatest drawbacks with port mirroring, is the lack of an ability to block and change traffic, rather than just monitor it.

In summary, the conventional solutions have various drawbacks, including blindness to spoofing and blindly trusting attackers, thereby unknowingly permitting an adversary to bypass the security controls using different attack protocols such that the monitor cannot see the communications and connections that an adversary wishes to hide. In addition, two computers on the same Layer 2 switched segment, for example, can merely talk to each other directly via bridging or via the use of an overlay IP network other than the primary network, thereby bypassing the monitoring network. Also, if a user chooses to spoof another, the monitor system doesn't always have visibility as to which port on which switch decided to connect using the stolen credentials from another device.

In light of the above, it may be desirable to provide a method and system for increasing the security of a network that is safer and less invasive such as simply placing the proxy or firewall in line without requiring IP changes in the network. The present invention addresses this need and provides related advantages as well. For example, systems and methods as provided herein may remove the physical or virtual enclave thereby improving trusted communications associated with the physical and virtual enclaves.

In accordance with one aspect of the invention, a system for shielding a network from malicious or unauthorized activity includes: a network capable of transferring at least one data packet between a first network location and a second network location; a first node operably associated with the first network location; a second node operably associated with the second network location; the first and second nodes being normally isolated from each other on the network to thereby prevent transfer of at least one data packet therebetween; a monitor operably associated with the network and located between the first node and the second node for continuously monitoring the at least one data packet, the first node, and the second node; a controller operably associated with the network and the monitor for selectively connecting the first node and the second node thereby permitting transfer of the at least one data packet therebetween only when the following conditions have been met: 1) a request for transferring the at least one data packet has been received; and 2) the at least one data packet, the first node, and the second node have been flagged as trustworthy; and the controller selectively isolates the first node from the second node when the request for transferring has been received, and at least one of the following conditions have been met: 1) the at least one data packet is determined to be untrustworthy; 2) the first node is determined to be untrustworthy; and the second node is determined to be untrustworthy; wherein the network is shielded from malicious or unauthorized activity by preventing unauthorized access to the network and unauthorized transfer of data with respect thereto.

In accordance with a further aspect of the invention, a method for shielding a network from malicious or unauthorized activity comprises: monitoring a network capable of transferring at least one data packet between a first network location and a second network location; isolating a first node operably associated with the first network location from a second node operably associated with the second network location; monitoring the at least one data packet, the first node, and the second node to independently determine whether the at least one data packet, the first node, and the second node, respectively, are trusted; allowing a request for connection between the first and second nodes and transfer of the at least one data packet therebetween when the at least one data packet, the first node, and the second node are independently determined to be trusted; and denying a request for connection between the first and second nodes and transfer of the at least one data packet therebetween when at least one of the following occurs: 1) the at least one data packet is determined to be untrustworthy; 2) the first node is determined to be untrustworthy; 3) the second node is determined to be untrustworthy. In this manner, the network is shielded from malicious or unauthorized activity by preventing unauthorized access to the network and unauthorized transfer of data with respect thereto.

In optional embodiments, the present invention can be used with systems and methods as disclosed in U.S. Pat. No. 8,291,058 issued on Oct. 16, 2012 and entitled “High Speed Network Data Extractor” and U.S. Pat. No. 8,472,449 issued on Jun. 25, 2013 and entitled “Packet File System,” the disclosures of which are hereby incorporated by reference.

In an aspect of the present disclosure, a method for protecting a network from malicious or unauthorized activity is provided. The method comprises: assigning a unique identifier to each port from a plurality of ports connected to the same network device; tagging a data packet transmitted from a given port using the unique identifier associated with the port; and determining whether to forward the data packet to a destination based at least in part on the unique identifier. In some embodiments, the unique identifier is a virtual local area network (VLAN) tag. In some embodiments, the network is a virtual network. In some cases, the data packet is encapsulated with VPN (virtual private network) tunnel information.

In some embodiments, the method further comprises mapping an IP address and an MAC address to a port via the corresponding unique identifier. In some cases, the method further comprises logging the MAC address and detecting spoofing based at least in part on a change of the MAC address and the unique identifier. For example, the spoofing is detected using a machine learning algorithm trained model. In some cases, the method further comprises mapping data specific to a device to a port via the corresponding unique identifier and encapsulating the data with the data packet. For example, the method further comprises correlating one or more domains with an entity based at least in part on the data specific to the device. The method may comprise building a reputation for the entity by at least monitoring the data packet.

In a related yet separate aspect, a system is provided for protecting a network from malicious or unauthorized activity. The system comprises: a controller operably associated with the network and is configured to: (a) assign a unique identifier to each port from a plurality of ports connected to the same network device; (b) tag a data packet transmitted from a given port using the unique identifier associated with the port; and (c) determine whether to forward the data packet to a destination based at least in part on the unique identifier.

In some embodiments, the unique identifier is a virtual local area network (VLAN) tag. In some embodiments, the network is a virtual network. In some cases, the data packet is encapsulated with VPN (virtual private network) tunnel information.

In some embodiments, the controller is further configured to map an IP address and an MAC address to a port via the corresponding unique identifier. In some cases, the controller is further configured to log the MAC address and detect spoofing based at least in part on a change of the MAC address and the unique identifier. In some instances, the spoofing is detected using a machine learning algorithm trained model. In some cases, the controller is further configured to map data specific to a device to a port via the corresponding unique identifier and encapsulate the data with the data packet. For instance, the controller is further configured to correlate one or more domains with an entity based at least in part on the data specific to the device. In some examples, the controller is further configured to build a reputation for the entity by at least monitoring the data packet.

In another aspect, a system is provided system for protecting a network from malicious or unauthorized activity. The system comprises: a network capable of transferring at least one data packet between a first network location and a second network location; a first node operably associated with the first network location; a second node operably associated with the second network location; the first and second nodes being normally isolated from each other on the network to thereby prevent transfer of at least one data packet therebetween; a monitor operably associated with the network and located between the first node and the second node for continuously monitoring the at least one data packet, the first node, and the second node; a controller operably associated with the network and the monitor for selectively connecting the first node and the second node thereby permitting transfer of the at least one data packet therebetween only when the following conditions have been met: 1) a request for transferring the at least one data packet has been received; and 2) the at least one data packet, the first node, and the second node have been flagged as trustworthy; and the controller selectively disconnect the first node from the second node when the request for transferring has been received, and at least one of the following conditions have been met: 1) the at least one data packet is determined to be untrustworthy; 2) the first node is determined to be untrustworthy; 3) the second node is determined to be untrustworthy; wherein the network is shielded from malicious or unauthorized activity by preventing unauthorized access to the network and unauthorized transfer of data with respect thereto.

In some embodiments, the first node is operably associated with the first network location via an identifier uniquely associated with the first network location. Similarly, the second node is operably associated with the second network location via an identifier uniquely associated with the second network location.

In another related yet separate aspect, a method is provided for shielding a network from malicious or unauthorized activity. The method comprises: monitoring a network capable of transferring at least one data packet between a first network location and a second network location; isolating a first node operably associated with the first network location from a second node operably associated with the second network location; monitoring the at least one data packet, the first node, and the second node to independently determine whether the at least one data packet, the first node, and the second node, respectively, are trusted; allowing a request for connection between the first and second nodes and transfer of the at least one data packet therebetween when the at least one data packet, the first node, and the second node are independently determined to be trusted; and denying a request for connection between the first and second nodes and transfer of the at least one data packet therebetween when at least one of the following occurs: the at least one data packet is determined to be untrustworthy; the first node is determined to be untrustworthy; the second node is determined to be untrustworthy; wherein the network is shielded from malicious or unauthorized activity by preventing unauthorized access to the network and unauthorized transfer of data with respect thereto. In some embodiments, isolating the first node from the second node comprises assigning a first unique identifier to the first network location and assigning a second unique identifier to the second network location.

It shall be understood that different aspects of the invention can be appreciated individually, collectively, or in combination with each other. Various aspects of the invention described herein may be applied to any of the particular applications set forth below or for any other types of the network management/security system disclosed herein. Any description herein concerning the network monitoring and security may apply to and be used for any other network management situations. Additionally, any embodiments disclosed in the context of the network security system are also applicable to the methods disclosed herein.

### Incorporation by Reference

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the invention will be obtained by reference to the following detailed description that sets forth illustrative embodiments, in which the principles of the invention are utilized, and the accompanying drawings of which:

FIG. 1 shows a block diagram of a prior art network illustrating lateral unmonitored connection between network devices;

FIG. 2 is a simplified block diagram of a network that is configured to provide forced monitor through an active controller to prevent security breaches to the network and connected devices;

FIG. 3 is a simplified diagram of tagged data packets;

FIG. 4 shows a block diagram of a prior art network illustrating a lateral unmonitored connection between network devices;

FIG. 5 is a simplified block diagram showing independent vertical connections isolated from each other by breaking lateral or peer-to-peer communications;

FIG. 6 is a schematic diagram of a patented accumulator used in conjunction with the active monitor/controller/filter of the present invention with the filter data including data collected from all devices, networks, hosts, website addresses, approve lists, blocklists, ownership lists, location lists, data packet information, and so on, for efficient deployment of the present invention;

FIG. 7 is a simplified block diagram showing data packets with VLAN tags;

FIG. 8 is a simplified block diagram illustrating an expanded view of the shielded network;

FIG. 9 shows an example of an active controller;

FIG. 10 is a diagram of four different MAC translation modes in VLAN to VLAN communications in accordance with the invention;

FIG. 11 is a schematic diagram showing a TCP data stream between the internet and a device; and

FIG. 12 is a schematic diagram showing a UDP data stream between the internet and a device.

FIG. 13 shows a chart illustrating the numbers between a worldwide implementation of an IPV6/32 global private trusted backbone.

It is noted that the drawings are intended to depict exemplary embodiments of the invention and therefore should not be considered as limiting the scope thereof. The invention will now be described in greater detail with reference to the accompanying drawings.

### DETAILED DESCRIPTION OF THE INVENTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Systems, devices, and methods of the present disclosure are provided to ensure a secure network that is shielded from various of mechanisms that may compromise the network and devices on the network. For example, the systems and devices may include a combination of plug-and-play hardware, software, global data, and AI services to provide protection against unaddressed information security threats and robust defense against cybercrime. The systems and devices may utilize the combination of database with real-time AI technology to prevent illicit behavior. In particular, systems and methods provided herein may allow for inserting independent audit and security monitoring hardware and/or software at every individual device connected to the network where the individual devices or systems were not previously trusted.

Certain Definitions

Unless otherwise defined, all technical terms used herein have the same meaning as commonly understood by one of ordinary skill in the art to which this invention belongs.

Reference throughout this specification to “some embodiments,” or “an embodiment,” means that a particular feature, structure, or characteristic described in connection with the embodiment is included in at least one embodiment. Thus, the appearances of the phrase “in some embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” “unit” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In some cases, a component can emulate an electronic component via a virtual machine, e.g., within a cloud computing system.

Moreover, the word “exemplary” where used herein to means serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Embodiments of the invention may be used in a variety of applications. Some embodiments of the invention may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, a wireless communication station, a wireless communication device, a wireless access point (AP), a modem, a network, a wireless network, a local area network (LAN), a virtual local area network (VLAN), a wireless LAN (WLAN), a metropolitan area network (MAN), a wireless MAN (WMAN), a wide area network (WAN), a wireless WAN (WWAN), a personal area network (PAN), a wireless PAN (WPAN), a virtual private network (VPN), a storage area network (SAN), a frame relay connection, an Advanced Intelligent Network (AIN) connection, a synchronous optical network (SONET) connection, devices and/or networks operating in accordance with existing IEEE 802.1Q, 802.3, 802.11, 802.11a, 802.11b, 802.11d, 802.11e, 802.11g, 802.11h, 802.11i, 802.11j, 802.11m, 802.11n, 802.15, 802.15.1, 802.15.3a, 802.15.4, 802.15.5, 802.16, 802.16d, 802.16e standards and/or future versions and/or derivatives and/or long term evolution (LTE) of the above standards, units and/or devices which are part of the above networks, one way and/or two-way radio communication systems, cellular radio-telephone communication systems, a cellular telephone, a wireless telephone, a personal communication systems (PCS) device, a PDA device which incorporates a wireless communication device, a multiple input multiple output (MIMO) transceiver or device, a single input multiple output (SIMO) transceiver or device, a multiple input single output (MISO) transceiver or device, or the like.

It is noted that various embodiments can be used in conjunction with one or more types of wireless or wired communication signals and/or systems, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, multi-carrier modulation (MDM), discrete multi-tone (DMT), Bluetooth®, ZigBee™, or the like. Embodiments of the invention may be used in various other devices, systems, and/or networks.

Conventional security solutions typically run security audit applications and collect traffic and event logging that occur at the end station or device, such as a desktop computer or server. Since the device producing the logs is the same device which an adversary may target in an attempt to bypass the security system and gain access to unauthorized data, neither the end station logs or the security audit features are independent, meaning that once a node is compromised, the adversary has root access to all of the logs as well, and may be expected to hide its tracks from the logs.

Some network security companies have developed firewall projects that are designed to implement firewall rules on individual hosts to protect them from external attacks from the internet. In servers, some implementations place a firewall as a virtual machine (VM) inside the host to be protected but logically between the host and the network. This is straightforward with many VM's, where a full UNIX firewall can be implemented in front of a Linux, UNIX, or Windows server. Within Windows, with the support of Hyper-V (a windows hypervisor), it is possible to have a full UNIX firewall running in a hypervisor within a Windows Host or Desktop to protect the end station. This approach has some drawbacks, for example, when it is not directly supported by the OS developer/vendor, the security solution may not continue working after OS patches and upgrades over time.

With on-host virtual machines (VMs) or software on the host, the audit is not independent. This is because it is notionally hard to determine whether part of a compromised machine can be isolated from compromise. For example, if an adversary has root access to a machine, such as a desktop computer, that adversary also has the capability to disable or bypass all of the virtual machines. Although initially a virtual machine provided at every protected device or node may be feasible, there still remains a level of uncertainty when a node is fully compromised because the VM running on the compromised node may also be compromised by an alert adversary.

In alternative embodiments, virtual machines can be used to associate with every node or protected device on the network, which can advantageously reduce the cost, and is to implement while providing a higher level of confidence that all activity at every node is monitored. It can block undesirable activity, especially when the protection is inside a different operating system independent from the operating system of the host device while running on that device.

### Obtaining Visibility Inside a Switched/Routed Enclave

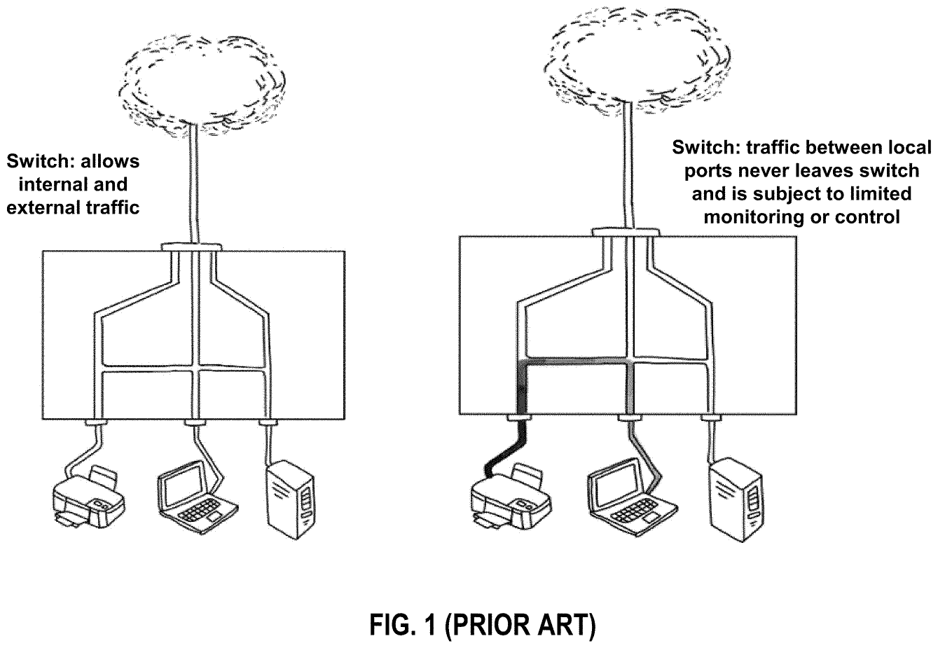

FIG. 1 shows an example of networks that include switches and routers. Such networks include the International Standards Organization (ISO) development of the Open System Interconnection (OSI) model. This OSI model defines a conceptual networking framework of seven layers for implementing network communications with each layer having a specific function. For example, Layer 1 in the OSI Model is considered the physical layer that conveys the bit stream via hardware as electrical, light, or radio signals for sending and receiving data on a carrier, with physical layer components such as cables, network cards, switches, and so on, via various communication protocols such as RS232, Ethernet, and so on. At the Data Link Layer 2, data packets are encoded and decoded, transmission protocol is furnished, and provides both Media Access Control (MAC) and Logical Link Control (LLC) sublayers to control how a computer or device on the network accesses the data and grants or denies permission to transmit the data, as well as frame synchronization and error checking. Network Layer 3 provides switching and routing techniques, create virtual circuits for transmitting data from node to node, as well as forwarding, addressing, error handling, packet sequencing, and so on. Transport Layer 4 provides the transfer of data between end systems or hosts and ensures complete data transfer by monitoring end-to end error and error recovery. Session Layer 5 establishes, manages, and terminates connections between hosts, including managing and terminating connections between applications at the hosts. Presentation Layer 6 is responsible for formatting and encrypting data to be transmitted across a network and ensuring the data is compatible with programs at the hosts. Finally, Application Layer 7 supports application and processes associated with the end user where communication partners are identified, user authentication and privacy are addressed, and provides application services for file transfers, email, as well as other services associated with access to network data. World Wide Web (www) browsers, e-mail applications, and other application specific programs are associated with this layer. As illustrated in FIG. 1, the switches map a device's physical layer address or MAC address to a respective port to which the device is plugged. When a device sends a packet to another device, if that destination's MAC address is found on another port of the local switch, the packet is transmitted to that port of the local switch directly. If the destination address is not on a user port, the packet is forwarded out via a trunk port toward the rest of the network, enabling other switches to forward the packet to its destination. In the example as shown in FIG. 1, a switch functions under normal conditions where communication between a laptop and printer occurs. When two devices are both local to the switch (i.e., connected to the same switch and visible in the mapping table of the switch), the traffic may not leave the local switch. An example of the above direct communication is when a laptop sends a printing job to the local printer.

Conventional systems, such as depicted in FIG. 1, may allow lateral communication between devices on a local network within an enclave. By way of example, the network devices can include a printer, laptop computer, and a desktop computer, smartphones, smartpads, wearable devices, smart televisions, other desktop or laptop computers, Internet of Things (IoT) devices, and so on. These devices can communicate with each other without leaving the local switch when powered up and connected to the local network.

The network depicted in FIG. 1 is a prior art model for lateral communications between devices within an enclave. It shows that there are no real bases for the common assumption that all devices within an enclave have a higher level of trust as compared to devices that are outside of the enclave. For example, once an adversary breaches one of the devices behind the enclave, all other devices within the enclave and their data are accessible to that adversary. Breaches can occur through, for example, compromised passwords, spoofing, hacking, and so forth. Moreover, as there is a higher level of trust among the lateral devices in an enclave, the breach by the adversary may often go unnoticed until several days, weeks, or months later. Such conventional network model may severely limit detection and mitigation of the breach.

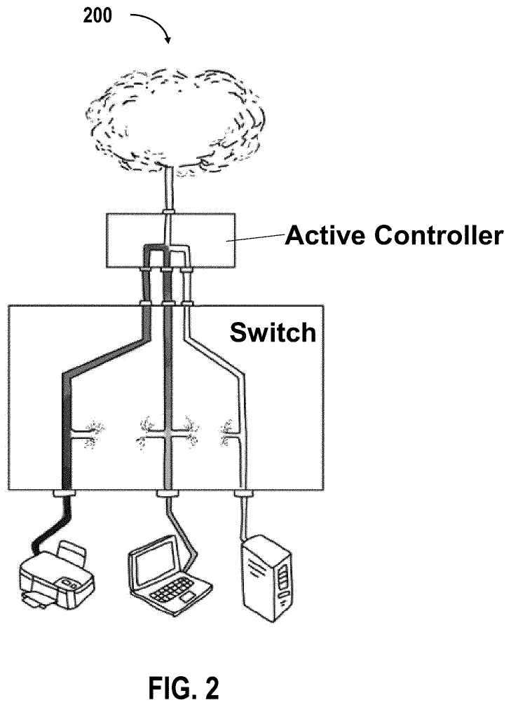

As described above in the description of FIG. 1, devices on the same local switch are not protected with respect to each other. As such, it is desirable to isolate the individual devices without reconstructing the network configuration. In preferable embodiments of the invention, methods and systems may utilize the components associated with Layer 2 of the OSI model, as well as the switches and routers associated with Layer 3. FIG. 2 illustrates a network 200 with enhanced security and monitoring features.

In certain embodiments of the invention, the Layer 2 bridging may be configured to assign a unique Virtual Local Area Network (VLAN) tag to every port associated with component in Layer 2. For example, in some embodiments, each port associated with the same local switch is assigned a unique VLAN tag. In these embodiments, as shown in FIG. 2, the transportation device (e.g., switch) ensures that networked devices (e.g., laptops, printers, desktops, and the like) are not capable of communicating with each other within the switch. The network 200, wherein the direct communication between networked devices is broken, can include, by way of example, up to 4096 devices on 4096 ports (or virtual ports) that cannot communicate with each other. The data packets transmitted between the local devices within the switch are forced to pass through an active monitoring system such as an active controller. The active monitoring system or controller may perform functions including creating audit records and blocking or passing each packet of traffic based on security decisions.

As illustrated in FIG. 2, the network 200 may force packets transmitted between the local laptop and the local printer to pass through an active monitoring system or controller. In some cases, the active monitoring system or controller may: 1) receive and examine the packets sent by the devices in the network; 2) determine whether a connection between the local devices (or other devices trying to connect in the network) can be established or permit/deny communication among local devices; and 3) depending on the decision, block or pass the traffic to the destination device.

In some embodiments, data packets transmitted from a port are associated with a VLAN tag that is uniquely assigned to the port. This VLAN tagging brands each packet transmitted with the VLAN tag that is uniquely assigned to each port such that no two ports on a monitored network have the same VLAN tag. This tagging beneficially enables isolation between local devices. In some cases, the packets sent to each port can be managed and analyzed separately by the active monitoring system or controller according to the VLAN tag. The active monitoring system or controller may manage and analyze the VLAN tag using any existing device tags management features in its purview. More than one VLAN tag can be used simultaneously using VLAN in VLAN encapsulation known commonly as QinQ tagging per IEEE 802.1ad which is an amendment to IEEE 802.1Q.

In some embodiments, a monitoring device is inserted into the network and configured as the only device on the network to which each of the other devices can directly communicate. This monitoring device may be referred to as a forwarding device, a monitoring system, an active monitoring system or controller, an active controller or a controller, each of which are used interchangeably throughout the specification. In some embodiments, packets received by the monitoring device are assured to have been transmitted from a specific port on a remote switch, thereby facilitating the construction of an address to port map for network protocols that is not subject to error or intentional spoofing.

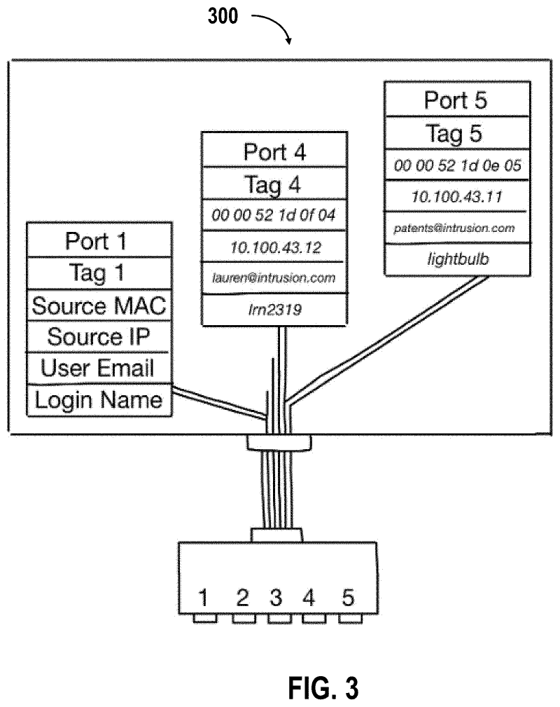

FIG. 3 is a simplified diagram of tagged data packets. FIG. 3 illustrates examples of tables that are managed and used by the forwarding device 300 (e.g., an active controller). In some embodiments, the forwarding device compares the illustrated tables to the port address tables stored in the switches as a source of independent audit. As shown in the example, MAC and IP addresses are each mapped to a port associated with a unique tag (e.g., a VLAN tag) that is fully attributable. Other data such as logins, emails, identifying credentials, sessions on all protocols and other device specific data may also be uniquely mapped to a port. By utilizing this tagging mechanism, the active controller can access the MAC address and IP address of the source and destination devices. This is an especially advantageous aspect of the invention as insider crime, spoofing, forging, posing, man-in-the-middle, and other signs of human or machine-based crime can be easily and quickly detected, and thus greatly advantageous over conventional solutions.

Conventional network monitoring devices may not be capable of collating statistics and history of transactions or traffic over time. For instance, conventional network monitoring devices typically collect port-based statistics that do not include a breakdown by communicant pair. Accordingly, although the total number of bytes received by a port from all devices in aggregate are known or can be determined, it is general not possible for such devices to determine or track from whom or where the data has been sent. Likewise, port statistics in the conventional network monitoring devices may determine the number of packets and bytes transmitted out a given port but may not be able to determine or track the number of packets that were sent to a given destination. The MAC address-based statistics as tracked and monitored by the conventional network monitoring devices may also not work through the first router because the source MAC addresses of each packet are overwritten at every router. Further, with DHCP leases of IP addresses having finite lifetimes, the statistics gathered for a given IP address over days, weeks, and months may reflect the statics associated with multiple different devices that are assigned the same IP address without the capability of distinguishing the statistics associated with each individual device.

In some preferable embodiments, each individual network device on each port is assigned a unique tag or identifier. In some embodiment, the unique tag does not change and is not shared by any other device on any port in the network. The unique tag or identifier may be, for example, a VLAN tag or any other suitable tag. The unique tag or identifier may include an encapsulation value, a set of values and/or other unique identifier protocol that can be uniquely associated with the network device. Accordingly, this additional tag information (which is preserved to the central audit and control server, e.g., an active controller) provides a stable audit and control point for all traffic to and from each device, so even if the IP address changes due to expiring DHCP IP lease times or any other reasons, the IP history and traffic statistics and IP communications records for each device are accurate. This isolated tracking feature provides improvement over the conventional network monitoring methods that use logging of DHCP lease requests and responses to pinpoint the time when a device stops using a previous IP and moves to a new lease, which is error-prone. In contrast, methods and systems of the present disclosure advantageously maps a device's MAC and IP address to a port and device at the packet level and, in some embodiments, is fully independent of the port address tables of switches and the uncertainty of lease times.

In addition, the present disclosure provides methods and systems that enable the instant detection of additional IP addresses used or attempted to be used by each device on the network. Furthermore, in accordance with the invention, as the unique identifier (e.g., VLAN) tagged packets are analyzed before any routing, the MAC address is logged on every packet and any changes in MAC address can be logged to monitor the activities. For example, MAC address change may be tracked and logged to denote new hardware, change of a device's connection cable, or the swapping of old for new hardware. This novel feature may also advantageously prevent spoofing since identity to physical port and device is based on the tag inserted by the switch and therefore cannot be spoofed by a hacker. Details about the anti-spoofing function are described later herein. While exemplary embodiments are described with respect to using VLAN to tag packet, one of skill in the art will appreciate that this is not intended to be limiting, and the tagging features described herein may utilize any other tagging or identifying methods for identifying each packet and port as unique can be used without departing from the spirit and scope of the invention.

In certain embodiments of the invention, one or more network centric monitoring devices can be provided for a single network and the devices connected to that network and is highly advantageous when compared to conventional solutions. Some of the more salient advantages of the present invention are described below, it being understood that other advantages will become apparent upon further consideration of the foregoing and forthcoming features of the invention.

Depending on several factors associated with the network, a single monitor/controller can be used, in accordance with the invention, to monitor all stations, notes, hardware, ports, and so on, with respect to traffic or data flowing into the network, out of the network, as well as laterally within the network between machines, hardware, ports, etc., to substantially reduce the cost of hardware, software, implementation, and maintenance, and is therefore much easier to manage than one monitor/controller per station, especially with conventional solutions where spoofing can still occur.

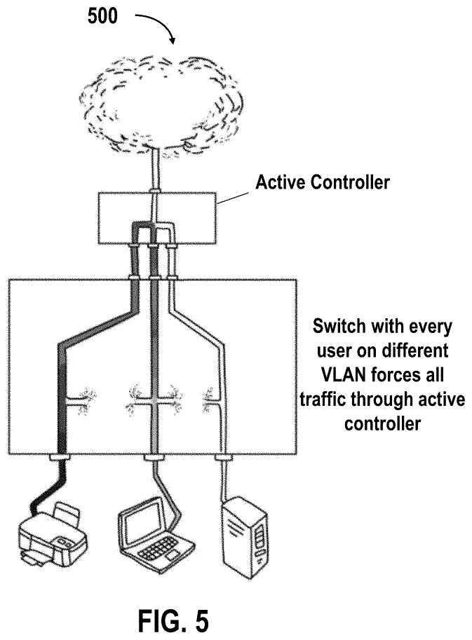

Although a single central monitor/controller is shown and described, for example in FIGS. 2 and 5, it will be understood that two or more monitors/controllers and/or other devices capable of performing the equivalent functions can be used to ensure the flow of data between trusted hosts is virtually unimpeded while protecting all devices within the network. The particular number of monitors and/or controllers will depend on the capacity and sophistication of the monitoring device itself, the size of the network, the number of connected devices on the network, the amount of data being monitored and transferred into and outside of the network, as well as laterally within the network between machines, nodes, hardware, and so on, and other factors. Accordingly, the invention is not limited to a single central monitor device but may include as many monitoring devices as practically needed, as well as back-up or redundant monitor devices in the event of device failure and/or for ensuring device integrity.

In accordance with a further embodiment of the invention, a first central monitoring device and a second central monitoring device can be connected in series and/or parallel so that network-related events associated with one monitoring device can be verified with the second monitoring device, thereby ensuring a higher degree of confidence in the integrity and authenticity of such events. In some cases, one or more additional monitoring devices can be used to provide further redundancy, flexibility and additional security. For example, some of the monitors can be provided offline in sleep or hibernation mode, and activated when needed to immediately come online when network activity or traffic increases, such as during peak work hours, or when an unusually high level of activity occurs before or after peak hours, such as during an attempted breach, to ensure that absolutely no data is transferred between hosts in such an event, then return to sleep mode offline until called up again to assist the full-time central monitor.

A disadvantage of a single monitor per station model, as afore mentioned, may require as many monitors as there are machines, nodes, IoT devices, and so on. The cost of such an implementation can be high, and therefore monitors provided at each station, node, etc., may of necessity be cost-driven. Therefore, the power and capabilities of each monitor may be severely restricted in light of the amount of individual monitors needed. Moreover, the upgradeability of such monitors, meaning the ability of the monitor to improve its tasks over time, such as through artificial intelligence (AI) algorithms or routines, may also be severely limited.

Since only a single central monitor or relatively few central monitors are needed to monitor all stations, machines, nodes, etc., in accordance with the present invention, the central monitor can be manufactured and sold at a higher cost, and therefore can be more powerful and capable of performing tasks than lower-cost monitors. Artificial intelligence (AI) algorithms or routines can also be implemented with the central monitor in accordance with a further exemplary feature of the invention, so that the central monitor improves its capabilities and streamlines its processes over time as more data is monitored and processed. Over time, more information becomes available with respect to the integrity of the network, the devices connected thereto, as well as the determined integrity and exposure to risk of remote hosts, devices, machines, and so on, with inadequate security, expired certificates, compromised credentials, and so on. With this more available information, the AI algorithms may train itself to detect a breach in the remote network and associated devices, or local network and associated devices, by adversaries trying to gain access to one or more networks and connected devices. Accordingly, the central monitor functions more powerfully as a control point for all activity coming in, going out, or moving laterally within the network, rather than simply a monitor unable to verify whether the source is trusted. Since none of the devices within an internal network is assumed to be more trusted than other devices outside of the internal network, the central monitor or control point may beneficially eliminate the need for an enclave and internal network.

In accordance with another embodiment of the invention, every packet between every device is both overserved and controlled by the central monitor, as it stands in between every device in the network and all other devices. This removes the ability for an adversary to move unnoticed laterally within an enclave. It also removes the possibility of malware, ransomware, spyware, etc., being injected into the devices within the enclave with the intent to damage, destroy, or steal the trade secrets and other vital information of the company associated with the enclave. Further, if a device is deployed onto the network which is already compromised, the invention will both prevent it from calling home to receive instructions and malware updates as well as prevent it from compromising additional nodes by moving laterally and infecting other nodes in the enclave or network.

In accordance with yet a further embodiment of the invention, a large number of internet devices as well as most IoT devices are connected with Wireless Fidelity (WiFi), Wireless Local Area Network (WLAN), or Cellular Network where radio waves are used to connect to a network, rather than through a wired Ethernet (or other ISO Layer 1 & 2 standard). Most WiFi devices allow direct lateral communications between WiFi devices without monitoring or controlling the data being communicated. Accordingly, these WiFi devices offer no security at the packet level, resulting in a low level of confidence that the data is from a trusted source. In this case, the Active Monitor of the invention will view traffic from each WiFi and IoT device using the same novel isolation technique as described above. As such, the present invention extends the monitoring and control described above with respect to wired devices to wireless devices in order to greatly enhance the security of the wireless device communications and the data being transferred. This is done by isolating every device to its own VLAN (or other encapsulation or tagging method) and thus block the direct communication between these devices. The communication between devices is forced to pass through the central monitor device (e.g., an active controller). This ensures that each wireless device is isolated, monitored, controlled, and protected using the same system and method of the invention as wired devices.

As described above, as the lateral wireless connection between WiFi devices is isolated, each packet is received by the central monitor/controller to prevent WiFi devices from forming peer-to-peer communications. In this manner, the wireless network can also be monitored to detect and prevent spoofing and other attempts by an adversary to jump airgaps using wireless communications that otherwise may be possible without monitoring. In addition, the system and method of the present invention prevents an adversarial device from attacking, exploiting, covertly communicating with, hacking, initiating a malware-free compromise, acting as an unmonitored data relay, and so on.

### Inserting an Independent Audit Between All Networked Devices

In accordance with a further preferable embodiment of the invention, with the system and method described above, no device can successfully send a single packet on any protocol to any other device in the network without passing through the active monitoring device, which can also be referred to a monitor/control node, or simply a control node, it being understood that various nomenclature can be used to describe the system, components, and/or devices associated with that system, along with the methods employed to operate within the system without departing from the spirit and scope of the invention.

Furthermore, if any device (either wired or wireless) makes an attempt to circumvent the monitor/control node, the circumvention is detected by monitor/control node (e.g., an active controller). The present invention is described herein using VLAN tags by way of example. The VLAN function currently used by switches provides full isolation between members of one VLAN and members outside that VLAN. Accordingly, the present invention can be implemented with such switches, thereby preventing direct peer-to-peer communications within switches when every user port is on a different VLAN. This beneficially prevents an end device from bypassing the monitoring and filtering of the active node. Although VLAN tags are discussed herein as one exemplary means for isolating and preventing direct peer-to-peer communications, it will be understood that other means for isolating, monitoring, and controlling communications between different ports, including laterally inside a network, as well as between different networks, virtual networks (e.g., VPN) as described by the exemplary embodiments or aspects of the invention below, and can be used either alone or in combination without departing from the spirit and scope of the invention.

In accordance with one exemplary embodiment or aspect of the invention, IP subnetworks can be configured to provide individual computers and other devices on a network each being assigned with an IP subnetwork with no other devices on the same IP subnetwork. In these cases, only the individual computer and a gateway, or another individual device and a gateway can be placed on one single IP subnetwork. The network control device can also be segmented in this manner using IP subnetworks instead of VLANs, with enforcement not allowing local communications or any other direct communications between any two nodes on a network, such that all traffic may be forced to pass through the control node (e.g., an active controller). If any pair of devices are compromised and for example assigned to an IP overlay network to communicate directly, this direct communication is blocked by the control node. This provides a security advantage as many classes of covert communications between local devices is invisible and not controlled on current networks. In addition, the unauthorized or compromised attempt is detected and docketed by the control node. In some embodiments, this compromised attempt may be used to build a block list, blacklist, or the like. In some further embodiments, this compromise attempt may be used as a training example to the AI algorithm to enable further improvements in detecting compromised attempts. This blocking method in accordance with the invention not only applied to the Internet Protocol (IP), but all protocols and bare Ethernet frames as well.

In accordance with a further exemplary embodiment or aspect of the invention, VPNs and other encapsulation methods can be implemented to preserve both single user isolation, as well as further encapsulation.

The provided systems and methods may also include security and monitoring to wireless network devices. In accordance with yet another exemplary embodiment or aspect of the invention, WiFi devices can be secured by tagging the WiFi users. For example, WiFi users are tagged to wrap a known control number around the traffic from each WiFi device, and are transported in this tagged state along data paths. Conventional WiFi hubs, network switches and routers are designed to shortcut the path between a sender and a receiver so that forwarding decisions and thus traffic paths stay as close to the edges as possible, and thus cannot be monitored by an independent monitor device. With the present invention, WiFi traffic is also purposefully isolated to groups of just one device so devices can only communicate with other devices when being monitored and allowed.

WiFi devices currently in service have the capability to communicate with each other without relaying through the WiFi access point itself, and further have the ability to function as WiFi repeaters or relays to external networks and devices. This creates a security risk. Accordingly, the present invention implements security isolation based on detection of ad-hoc peer-to-peer WiFi communications, WiFi repeaters, and connections to external networks and devices by using a strategy in accordance with the invention that wirelessly monitors and mitigates a typically unmonitored external relay. Because each WiFi device directly connected to the network is closely monitored by the central controller (e.g., active controller) to detect the direct connection, and because of the above-described the one user per VLAN tagging, IP subnetworks infrastructure, if a device forms an ad-hoc connection, that device may be isolated and cut off from the network as a security violation, as the network cannot be assured where data and commands exchanged with that device came from. In some cases, the detection can be performed passively by a WiFi listening device to ensure that a particular device is only communicating with a single WiFi gateway within the controlled infrastructure. The active controller may then use these detected security violations as training examples to the AI algorithm to further improve the performance of the active controller.

With the above-described embodiments or aspects of the invention, one or more frameworks can be formed, when used in combination, to monitor and control communications for both wired and wireless devices connected to a network to thereby eliminate all blind spots inside an enclave and prevent virtually all attempts to gain unauthorized access to a network and device(s) within the network. As described above, conventional security models cannot prevent adversaries, cybercriminals, and the like from attempting to gain unauthorized access to a network or device within the network (e.g., within an enclave). further, conventional security models cannot monitor communications between devices within a network (e.g., within an enclave), which allows free access between devices. With the present invention, every packet between every pair of devices is viewed by the above-described framework of the invention and transmits over an isolated path that guarantees proper attribution.

The above-described framework can advantageously prevent an adversary from intruding and operating inside a network without being observed. The adversary is prevented from scanning devices connected to the network. The adversary is also prohibited from relaying, hiding, spoofing, and implementing either fast attacks or slow scans. Moreover, the adversary is no longer able to EXFIL data, and is prohibited from commandeering devices on the network and relaying command and control commands to the devices, and so on. In accordance with certain embodiments of the invention, each connection may have a legitimate purpose; every data or control communication is monitored to determine whether it fits or does not fit within the confines of expected behavior by an active controller optionally implemented with AI algorithms. Accordingly, cybercrimes and breaches will have full accounting from an independent source, and all flows of communications are monitored by implementation of the invention.

Furthermore, since the invention requires every data path to pass through an active filter, which includes a series of huge global reputation, ownership, geolocation, role, function, and zero trust authentication principles that will create a very thorough data prison. No data communication can occur without being noticed and monitored and thus provide full attribution. Further, a family of universal rules will be mixed with thoroughly vetted approve lists and known blocklists and behavioral history to block potentially malicious actions from happening. The centralized machine learning system of the invention assumes that all actions attempted by any entity on the approve lists are untrustworthy. Accordingly, even if an approve-listed device, program, command, communications, network, node, etc., performs an expected action, the more centralized machine learning system of the invention will not blindly trust white-listed activity but will perform an independent analysis to determine whether to block or allow such activities as described herein.

### Inserting Communications Control Between All Networked Devices

In accordance with a further feature or aspect of the invention, a detailed description relating to inserting active security controls, which is capable of detecting and stopping data exfiltration, detecting relay exploits and hoarding/theft by users and spyware, detecting and stopping external control, performing differential analysis, performing covert communications detection, active filtering, and detecting traffic modifications between every single networked device and every other device. These implements will be described in greater detail below.

In order to fully appreciate this aspect or feature of the invention, it is important to understand the state of conventional firewalls and the like. Firewalls may only monitor and filter the gateway between two networks, usually between the internet and a private (or often just a single local) network. Firewalls have matured to be very sophisticated products, but their intrinsic nature is to block connection attempts from the outside but allow insiders to connect to the data and/content they requested.

Such conventional firewalls and the like may not be able to effectively protect devices from cyberattack because trade secrets, product manufacturing know-how, software, data, and relationships, and the like can be stolen without being noticed if an adversary gained access/took over control of one of the devices inside of an internal network (e.g., inside of an enclave). Most of these thefts of private data are silent and slow killers, in that the organization or individuals doesn't notice the breaches of data security. Adversaries have a new tactic to extract cash from those they penetrated as described below. Attacks first land on a single device, then use the lack of visibility and controls within an enclave (a private network isolated from the internet) as cover for compromising as many nodes as possible without being monitored. The ransomware attack then encrypts all of the data and offers to share the decryption key and method with the victim (e.g., data owner) in exchange for relatively untraceable crypto currency, for example. An impressive percentage of ransomware companies do not survive more than six months after a ransomware attack. Some lose a critical amount of customers due to loss of trust, interruptions of deliveries, loss of their internal databases, customer lists, software, product manufacturing and creation knowledge bases, and so on. These companies lose the data they accumulated for years along with money. Some of the ransomware attacks are launched to extort the business and get cash while they never intend to share the decryption keys, so the real malicious purpose of such attacks is to drive a competitor bankrupt and extort their remaining money. Further, by the end of 2019 more than half of compromises are now malware free, meaning that no malware was used in the security breach. Since then, the size and number of major breaches continue to rise. An analysis of such breaches reveals that conventional security models are insufficient when it comes to protecting a company's data. Conventional security solutions fail to protect from such breaches, despite the use of what may be considered the best security solutions. As described above, conventional security solutions face outward to fend off attacks, but the breaches are already accomplished from a wide variety of history, compromises built into hardware and software purchased, exploits, back doors, employee credentials guessed or stolen, and purposefully delivered exploits by adversaries. Thus, the present disclosure provides data security solutions addressing these data breaches.

As described above, modern networks can be vulnerable because once a single device is compromised within the network, moving laterally inside a local network (e.g., within an enclave or within an organization) is relatively undetectable and unstoppable. Many companies, organizations, and private entities purchase items for business and home based largely on price. As the majority of security cameras, thermostats, door alarms, computers, servers, routers, firewall hardware, and other systems, devices, related software, including apps, are made in countries where labor is cheap, the exchange rate is low, and expedited shipping is usually free, such systems, devices, and software may come prepackaged with spyware, ransomware, etc., to steal technology and create massive damage in the process, especially when such countries secretly or openly become adversarial to the country or countries where such items are sold. Conventional security solutions have not been able to adequately address such compromises. In some cases, devices that were trusted just a few minutes ago can and do become part of an active operation against governments, companies, entities, and individuals that employ such devices.

In another aspect of the present disclosure, a novel zero-trust model is provided for improving the network security and monitoring capability. Zero trust postulates that a portable device should be treated the same whether it is inside a data center or in a hotel lobby on WiFi. If it is trusted, it is allowed to communicate. Likewise, if a device inside a network (e.g., an enclave) is not explicitly trusted for a particular access, it is rejected with the same strength as a known malware host on the open internet. Zero trust implies zero intrinsic trust, unless the trust is earned.

In accordance with a further embodiment or aspect of the invention, systems and methods are provided for monitoring, filtering, auditing, and controlling communications between each device within a network, as well as communications attempting to flow into and out of the network. The monitoring, filtering, auditing, and control between each device on a network can be accomplished without requiring a separate security monitoring and control device for each end point (such as a desktop, laptop, server, router, bridge, gateway, VPN gateway, each single remote device, as well as each IoT device connected to a network, and so on). As described herein, obtaining visibility in a network is enabled with the present invention, where all communication is monitored. Thus, systems and methods for recognizing many security issues and removing such issues, including security breaches in real-time, are provided, as described with respect to the following unique features of the invention.

A novel feature of the invention for controlling communication to and from every device in the network includes allowing the enforcement of connection rules and communications flow rules within an enclave as well as all flows to and from the outside world with respect to the protected devices. Since the local communications of switches are inhibited, only packets that are passed and/or approved by a unique filter (e.g., an active controller) will ever reach their destinations. This invention therefore comprises a unique and novel complete internal flow analysis and flow controller, whereby every single device is individually isolated, analyzed, and protected from all other devices, and vice-versa, where every device is protected from any device compromised by an adversary.

Certain embodiments of the invention enable the use of traffic flow analysis to recognize theft of data or data streaming out from the protected network, including enterprise networks. Alternatively or additionally, systems and methods as described herein may enable the use of traffic flow analysis to recognize a device or service presumed to be good as being suspicious.

In some cases, systems and methods as described herein are capable of blocking of network scanning and attributed to the device that does the scanning. Scanning is one of the steps an adversary uses to discover devices to compromise. Since a device doing scanning fits the characteristics of an internal hacker's pre-scan, the scans will be blocked. Alternatively or additionally, the systems and methods are capable of blocking of connections to hosts that have been set up recently, as well as domains that have been registered lately. Thus, the invention enables the blocking of connections to newer or uncharacterized domains which are owned, operated, controlled, or share resources with adversaries.

In some cases, systems and methods as described herein may include determining if an IP has never been a host. If not, then the connection is assumed to be questionable and the connection to that IP is blocked. The connection to IP's is considered even more questionable or sketchy if the IP is within the netblocks (ranges of consecutive IP addresses), which may have been used for illegal purposes, as well as connections to anonymizers (anonymous proxies used to make activity on the internet untraceable), virtual private servers (VPS) hosting facilities who harbor cyber operations, and enables blocking of the same, especially when operated by known bad actors. In some cases, the systems and methods may be capable of blocking of connections to hosts when inverted flow has been discovered by the monitor/controller or other device.

Alternatively or additionally, systems and methods described herein may be capable of blocking of connections to hosts that are not from a Session Initiation Protocol (SIP) or a TCP/IP connection for Voice-over-IP (VOIP) telephony allowing for example video conference calls for example, or for a “Software (SW) Update Available?” “call-home” inquiry. These connections to hosts may issue constantly. Such beacons are typical of “phone home” or “call-home” malware.

In accordance with another feature of the invention, the monitor/controller detects and monitors continuous connections for signs of terminal reversal, particularly when some outbound connection is associated with a small number of bytes inbound. This can be accomplished by looking for terminal proxies from servers.

In some cases, systems and methods described herein may include assigning a risk score or level based on past activity, suspicious behavior, manufacturer, country of origin(e.g., hostile countries), or other countries where known prior breach attempts have been made or are likely to be made, attempts to break out of role, attempts to spoof, forge, scan, or compromise any device in the network, and so on. The risk score or level may be stored by the system as reputation associated with devices.

In some cases, systems and methods described herein may include disabling trust and/or assigning an untrustworthy marker or flag for new servers owned by prior criminals or criminal organizations. A machine learning algorithm of the invention correlates the ownership of multiple domains by the same entity or entities, so that the reputation of such entities carries over to the new domain(s), especially when one or more of the old domains has been used in attempted cybercrimes. Thus, the prior reputation of old domains is automatically associated with new domains when there is common ownership of the old domains and the new domains, so to flag the new domains (servers) as untrustworthy by default. This aspect of the invention includes the monitoring and control of IP ranges, domains owned by the same owner/group, hosting centers that cater to cybercriminals, Border Gateway Protocol Autonomous System (BGP AS) numbers used by criminals, nation states information operations, and the like, to ensure the safety of the network and devices connected thereto. This aspect is unique to the present invention, as conventional solutions have not addressed the common ownership of old and new domains when the old domain(s) have a prior compromised reputation.

In some cases, the systems and methods may mark new servers as untrustworthy when the new servers are detected to be hosted in hosting centers having a high percentage of cybercriminal history. Additionally or alternatively, the systems and methods may monitor BGP AS numbers to determine whether they are untrustworthy when associated with a high percentage of cybercriminal activity.

Another aspect of the invention includes making real-time edits of Domain Name Systems (DNS) answers so that user devices are never allowed to choose a server in a blocklisted or less preferable location. DNS can be messy with mirrors located all over the world. Many organizations have policies in place with respect to connections, especially data flows to some countries. However, a DNS A (which specifies IP addresses corresponding to a domain and its subdomains), NS (a name server which indicates which DNS server is authoritative for a domain), MX (specifies where the emails for a domain should be delivered) or other DNS record answer may contain many IP addresses from around the world, which are all considered mirrors or alternates for the DNS name looked up. Accordingly, this unique and novel aspect of the invention offers the verbatim DNS answer provided by the authoritative DNS hierarchy or a DNS Sink Hole answer which leads to nowhere. In accordance with a further embodiment of the invention, an alternate or additional aspect includes offering a DNS answer that points the user to a rendering sandbox instance for addressing a variety of encountered threats facing internet users.

The abovementioned functions, features and components of the systems and methods may greatly enhance visibility of connections within a network, data flow between devices in the network, as well as data flow in and out of the network to monitor and thwart attempts to breach the network, thus keeping all devices and data associated with the network shielded from such attempts. The systems and methods as described herein thus provide unique and novel solutions for implementing automated analysis (e.g., AI algorithm, Machine Learning algorithm) leveraging the above-described enhanced visibility.

In accordance with a further feature or aspect of the invention, as discussed above, differential analysis is enabled, wherein every packet sent to and from a device is counted, analyzed, decoded, and a series of comparisons are made. At the lowest level, differential analysis involves just counting packets. If two adjacent nodes in a network are bridges or routers, the packets leaving one are destined for the next one. If the count of packets leaving one node are more than the number delivered to the next node, it is determined that the network has lost one or more packets. If the count of packets arriving at a node are greater than the number that left the adjacent node, it is determined that a “a man-in-the-middle attack” is occurring, where an unseen device is inserting packets into the traffic. If the counts are identical, but the packets differ by a single bit or more, it is determined that an unseen device (or noise) is modifying traffic. When a packet is modified and the checksums have been recalculated to show that the packet has no errors, then it is determined that a clear case of active manipulation is occurring, and the node(s) doing the modifications has been discovered. Thus, differential analysis of packets in accordance with the invention enables packet monitoring on every cable and/or wireless path connecting every device in a network. In addition, the active, real-time detection of non-linear behavior by a networked device is another critical aspect for achieving security by reducing an adversary's ability to insert unexpected behavior in a network.

In accordance with a further aspect of the invention, covert communications may be detected by the central monitor/controller (e.g., an active controller), or other system, method or device capable of performing the described functions. The goal of adversaries is to make their covert communications invisible. Adversaries have used a great many covert communications methods over the years which are designed to be impossible to detect using the tools and logging present on a network, especially considering the sum total of devices sold and used around the world. The necessary goal of a defender is to detect and mitigate each and every covert attempt to data breach. The above-described features and methods of the invention enable the central monitor/controller or the like to have visibility to all traffic. For Example, packets on all paths (wired or wireless) in a network are visible to the central monitor/controller. In order to understand implementation of this aspect, the following example should provide some insight: in a rail yard, thieves learn where cameras are located and where the blind spots are. If thefts are correlated to where a boxcar was parked, patterns can be discovered. Likewise on networks, there are compromised nodes which are controlled by an adversary—and unexpected behaviors at nodes are indications of that compromise. Conventional solutions regarding differential analysis of packets in flight cannot be performed at network scale because of the lack of visibility to compare each packet in the context of each communication between every node.

The conventional solutions may include port-based packet and byte counters. Although such counters may seem helpful for detecting non-linear behavior, the problem is one of routing, since not all packets that leave a first port arrive at just a single second port. In these cases, the number of packets leaving the first port do not equal the number of packets arriving at the second port, thus throwing off the port-based packet and byte counters, so that the counters are not capable of seeing all the packets. In addition, bad packets are systematically discarded by monitoring systems, resulting in further losses of visibility because counts don't add up. In some cases, adversaries purposefully craft packets that may be ignored or discarded as covert messaging or survey tools. The rare network forensics person who is knowledgeable enough to detect novel covert communications may start with raw packet captures at one or more points and manually look for unexpected communications across an almost infinite scale of possibilities a knowledgeable adversary can create.

Thus, in accordance with the invention, non-linear behavior is preferably detected based on monitoring all traffic with full decodes and considering all modifications between every node on a network. The discovery of non-linear behavior by the central monitoring device or controller or other system, method and/or device capable of performing the monitoring functions, provides the visibility to find not just high-level activity, but also to find the signs of non-expected behavior and to immediately know which device behaves in an non-expected manner. Note that in the case of insider crime, there is no difference between a spy using a computer and spyware loaded on the computer. Differential analysis is not just between successive hops in the journey of packets across a network, but differential analysis of activities over time by all nodes on a network. Thus, different machines or devices (computers, routers, bridges, phones, TVs, IoT devices, and so on) have unique traits as compared to other devices on the monitored network, with the present invention enabling the determination of which machines or devices behave differently in some places than in other places.

The conventional solutions are replete with white papers, studies, and reports prepared by researchers and others that have designed different methods for hiding traffic from observation and for performing network discovery, reconnaissance, NAT and firewall traversal, remote control, injection and removal of data/code, data exfiltration, data deletion and/or encryption for extortion or disruption/destruction of an entity, as previously discussed. Systems and methods herein provide independent instrumentation at the packet level to detect catalogue evidence, disrupt, mitigate, stop, or take more sophisticated actions against an adversary. The independent instrumentation of the present disclosure, which can be embodied as hardware, software, as well as combinations thereof, feeds artificial intelligence (AI) algorithms and machine learning routines with high fidelity data. Conventional solutions are insufficient when compared to the adversary's advanced arsenal of cyber weapons—a battle which defenders are losing more and more over time. Accordingly, the present invention provides powerful tools as described herein to defend cybercriminals by destroying attempts to breach a protected network, and individually shielding the devices and data associated with the protected network.

The present disclosure provides improvements over conventional solutions. Security researchers usually conduct differential analysis by hand through a highly manual process that requires one or more packet recorders to record traffic for analysis. It is extremely time consuming to do in-depth analyses, even just for the packets captured from a single device by a monitoring device. Once some unexpected behavior is found, tracing it to the source often takes weeks or months because the adversary may use a number of different tactics and the detected behavior may not happened in a short period of time. Some adversaries wait a year between steps in a process of compromises. In addition, the expert cannot determine what may have been seen if they had manually looked somewhere else on the network. Moreover, the security industry is severely hampered by a very small number of experts capable of manually performing extremely limited differential analysis work. The present invention enables the use of AI algorithms and machine learning routines which provide advantages over the security expert's very limited capacity to manually monitor traffic at a single node at a time and to determine where that traffic went and what may have changed during the transfer of data between the single node being monitored and any number of nodes that cannot be possibly monitored by the expert. The ability to monitor all nodes in real-time is more thoroughly described in the U.S. Pat. No. 8,291,058 issued on Oct. 16, 2012 to Head, et al., and entitled “High Speed Network Data Extractor”, the disclosure of which is hereby incorporated by reference. For example, summaries of all traffic may be kept for many years, in comparison to conventional traffic recording solutions that produce so much data bloat that the archives are too big to keep long enough to see long-term compromises and low and slow adversaries. Accordingly, the present invention together with the methods and systems described in the '058 patent enable graph analytics, machine learning, and long-term differential behavior-based detection, as well as the blocking of undesirable behavior.

### Detecting and Blocking Spoofing

The various features, aspects, and embodiments of the invention, as described above, further enable the implementation of full monitoring and control of all communications between all communicants on a network, including large or global networks. One of the salient features of the present invention includes the detection of spoofing. Spoofing is normally understood to include both MAC address spoofing as well as IP address spoofing. On many networks, conventional solutions include the placement of restrictive filters by administrators such that only specific IP or MAC addresses are allowed to communicate with a port on a device. When packets are received from any node or device outside of the specific IP or MAX addresses, it is assumed that the packets are from an adversary and the packets are simply dropped as a security measure. The countermeasure for an adversary is to change the MAC or IP address (spoofing) of the adversary's device to match an address on the pass list.

However, in accordance with a further feature or aspect of the invention, the active monitoring device wraps source MAC address and source IP address in a distinct tag for each computer, port, or Wi-Fi connected device. Every packet a device transmits is preferably decoded and logged, including the MAC address and IP address (if it is an IP packet). For example, if a device spoofs the address of another network device, the present invention removes the uncertainty surrounding who attempted the spoofing by tracing back the source MAC address and/or IP address. The same is true with respect to the use of sub-interfaces to create an IP overlay network, as well as tunneling, where IP over IP tunneling is used. The present invention enables the logging and analysis of such data to determine if the monitored behavior is indeed spoofing, hiding, or serves a legitimate purpose. For example, IPV6 or IPV4 wrappers are placed around covert traffic exfiltration from victim networks to hide the actual destination of the communications—such as using public gateways to hide threatening destinations.

On normal switched networks, an adversary can duplicate the MAC and/or IP address of another device and the device port maps may move the device to the spoofer's port, then back again to the real port later. This seldom leaves a trail in the logs and is hard to find. With the present invention however, when a device on a port sends just one packet with another IP or MAC address, it is logged by the central monitor/controller or like device, along with the port tag so that there is no doubt that it happened or on which port or switch the spoofer resides. A series of Machine Learning algorithms, in accordance with the invention, have been developed to differentiate between a laptop moving around the building and plugging into multiple places as opposed to a machine that changes its MAC or IP addresses to spoof. For example, a machine learning algorithm trained model may process the packets with the unique tags as input and output a prediction about an existence of spoofing behavior.

### Detecting and Blocking Credential Sharing and Quantity of Logins

In accordance with the invention, the Active Monitor preferably performs protocol decodes and maps usernames to a device and port/location via the VLAN (or other tags and encapsulations previously described) directly for protocols where the username is not encrypted in transit.

Referring back to FIG. 3, a diagram representing exemplary ports with four nominatives (out of a very large number of potential attributes) listed to each port and device (Source MAC address, source IP address, sender's email address, user's login name, for example). There are hundreds of protocols and thousands of interactions with remote devices. For example, one derived attribute of a client can include the query: “Is there a human present on this client machine?” based on traffic alone. Another exemplary attribute for a server query can be “are there any clients connected to this server? Which clients and when did each connect last?”

This feature or aspect of the invention is different from may conventional security measures—the default method for a corporation to look into mischief is to create enterprise certificates for all computers on the enterprise network which allow the network security staff to decode all messages. However, this may present a number of shortcomings. For example, if usernames and passwords are decoded then sent for archiving in the security audit world, that audit record set becomes the master set for an adversary to steal or purchase from an insider. Current trends in security are moving toward certificate pinning to support a zero trust model, which makes corporate man in the middle or law enforcement decoding of encrypted traffic increasingly impossible. The present invention therefore utilizes machine learning to recognize that a secure login occurs without decoding it. In many cases, successful logins and failed logins can be determined with simple traffic analysis, but machine leaning (and the corresponding AI algorithm) in accordance with the invention enables this process to be automated in mass. Mapping login attempts to device and time creates an independent source for detecting shared logins, for example when the user that successfully logged in wasn't on the assigned/authorized machine for that user. This independent audit source can also be compared with native login logs to discover which machines share the same logins with which resources. The following scenarios showing an exemplary automated process of tracking logins and failed logins to determine potential breaches or attempted breaches are given by way of example only.

With Secure Shell or Secure Socket Shell (SSH) network protocols, the active monitoring device detects both valid and invalid logins, which device on which port logged in successfully to each server, as well as the number of failed logins and their location(s).

With Kerberos pre-authentication, the present invention correlates usernames to port and device, and which device on which port logged in successfully to each server.

With FTP, the present invention monitors the username for logins and passwords, which are both sent as clear text, monitors which device on which port logged in successfully to each server, as well as the name size and checksum of each file uploaded or downloaded.

With respect to Telnet, the present invention monitors the username for login and password, which are both sent as clear text.

Likewise, the present invention can monitor SMTP communications, including login, password, time of login, number of successful and unsuccessful login attempts, and so on.

Thus, in accordance with the present invention, logins are tracked with respect to communications or security protocol to find malware, ransomware, and criminal insiders, especially by tracking and tracing failed login attempts from insider to insider, from outsider to insider, and insider to outsider. With zero trust, any device can flip from friend to foe in a few thousandths of a second as an adversary takes control of it, which is monitored by the central monitor/controller or other active monitoring system or device. The number of failed logins and all of the recorded metrics are not merely used to block rogue devices and users from a login, but instead to permanently mark them as untrustworthy until remedied. With the present invention, spying can be discovered by monitoring the logging in to the accounts of others with their usernames and passwords, while they are not in the office. Conventional security systems fail to monitor such activities, because they are incapable of recognizing or capturing any of this behavior, much less blocking any logins, or banning the unauthorized user until resolved by security management. One of the fundamental aspects of the present invention is to employ systems, methods, devices, software, algorithms, and so on, for monitoring and recognizing malicious and illegal behavior, and to flip a trust switch from to “no” for all activities when a person or machine becomes untrustworthy. The novel application of the various features, aspects, and embodiments of the invention enable complete visibility of all devices, traffic, behavior, incorrect logins, correct logins by unauthorized users, and so on, along with correlating all such information within an enclave so that complete and total control over the security of a network and its devices is now possible by implementation of the invention. Without complete visibility, such as with conventional devices, systems, and solutions, networks remain vulnerable to unseen attacks which, as discussed above, can completely destroy a thriving company within a very short time when its data is stolen, encrypted, and in many cases permanently lost, even after ransom has been paid to the unknown perpetrator. Thus, with the Active Monitor of the invention, all traffic, including connections, devices, and corporate repositories can be monitored and controlled, and the perpetrators discovered since as each employee and machine are also monitored.

### Detecting and Blocking Identity Laundering

With identity laundering, adversaries purchase or steal large lists of usernames and passwords. Data extracted from the large lists are then tested by potential purchasers, to determine a whether a satisfying percentage of such information is valid before paying for them and prior to operational use. Most organizations use Network Address Translation (NAT), Reverse NAT, or Double NAT, where in general the IP addresses of computers in a local network are translated to a single IP address to thereby limit the number of private and/or public IP addresses an organization, company, etc., uses, for both security and economy. However, NATs are not capable of knowing where employees are located when they attempt to log in remotely.

It has become common for cybercriminals to try and hop to another node so that their crimes don't lead directly back to themselves. These crimes can be committed for example from a neighbor's house three houses down by attaching to the neighbor's house via WiFi in the hopes that investigators may only investigate the neighbor and search their computers for signs of the criminal activity—then give up. Likewise, it is a common trick on LANs to hop to a server or another user before logging in with stolen credentials. Because the cybercriminal's own computer is not being used, the criminal activity may point to the owner of the stolen credentials. Thus, when criminal logs in with several different stolen sets of credentials using relays—this is a form of identity laundering which the mapping of users, logins, and SSL login sessions to port and device, in accordance with the invention, builds evidence not available with conventional solutions. Especially when faced with proxies, NAT's, reverse NAT's, double NAT's and other machines as proxies, the present invention can monitor all such activity and preventing access to the secure data by an unauthorized person or device.

Accordingly, in NAT networks of any architecture, the presence of any NAT, even static NAT where a user acquires the same static IP address every time—the logs are always partial on both sides of the NAT with conventional solutions. This may lead to the result that either identity or location may not be detected when the VPN login and the system logins are different. To address these shortcomings, the present invention can correlate network traffic even when encrypted, and definitively tie remote IP addresses and communications to time of event. This removes the blindness on both sides of the NAT and allows many desirable security correlations to be made, even without system logs from the VPN or hosts. Machine learning algorithms in accordance with the invention are used to map users to devices, those devices used as relays will be disabled from being used as relays, and shared credentials will be visible globally. Therefore, the active monitoring device or active filtering device that may have full visibility with certainty regarding the source device for the data and the transportation protocol.

### Preventing Lateral Movement, Preventing Compromise of Additional Nodes From any Beachhead, Discovering and Blocking Beachhead

When a device produces audit logs and/or tries to block adversary activities—there is no independence and no separation from the adversary that obtained access to that device. Accordingly, conventional solutions fail to take measures when an adversary gains root access to a device. When an adversary gains control of a device (or had control of it all along since the adversary may be a manufacturer that embedded code in the device)—a natural thing to do is to hide its tracks from the logs and disable or cripple defenses. Therefore, end point (e.g., end station) defenses cannot defend against compromises in and of themselves.

A further aspect of the invention provides independent audit, monitoring, filtering, isolation, and other controls including the insertion of deeper scrutiny, as well as at the edges of a network.

Lateral spread is defined as using any beachhead in a network as an attack vector to compromise additional nodes. This is especially true of configuration management servers and enterprise management servers, where compromise of a single node allows an adversary to spread compromises to the entire enterprise network in the same manner as any updates.

The present invention enables discovering and blocking the beachhead. In some instances, the exploits are automatically spread from a beachhead—in other cases a hacker may manually assess the networks, searches for internal resources, assays the value of the breach from the hacker's perspective, and fine tunes the spread, covcom, data EXFIL, ransomware encryption rollout speed, and so on.

There are many algorithms and methods to create behavior rules, blocklists, and approve lists for laying down the initial triage of communications allowed and blocked for preventing internal spread—such as failed logins, number of logins, number of machines under the control of one machine, and so on. Although these metrics are used in of conventional solutions, the present invention does not stop with monitoring such rules and lists, but goes further to actually stop the suspicious, illegal, or undesired behavior once detected in real-time. The present invention accomplishes this by providing for per-packet and/or per-relationship pass/block enforcement on all connections between all devices without needing the cooperation of the compromised end device. With these novel improvements, such as attribution to port and device as described above, lateral spread is both discoverable and controllable.

This additional feature or aspect of the invention provides improvements in data flow direction, management control direction detection, and full communications relationships mapping that together enable the detection and stopping malicious activities of the beachhead. This is critical to cover all nodes, since any node on the network can potentially be compromised as an entry beachhead for the adversary. Systems and methods as described herein may employ both communicant pairs and data flow direction to discover the potential and activated beachheads which are communicating with the adversary's proxies. In some cases, these communications are on regular intervals.

It is known that one of the weakest security links in a network is most often associated with one or more IoT (Internet of Things) devices. Thus, in accordance with a further feature or aspect of the invention, monitoring is enabled for all client devices, all beefy machines, and all lightweight IoT devices which do not or cannot accommodate end device security clients or code. This ability is critical to prevent lateral movement between devices and/or nodes within an enclave or subnetwork. When a device does its own auditing and control, it becomes compromised when an adversary gains control of it (or had control of it all along). If an adversary has sufficient knowledge to bypass any security mechanism and take control of the device on the network, it can be assumed that the adversary will also know how to disable or edit his or her tracks from the network logs, thereby disabling or isolating the security software from seeing what the adversary wishes to hide.

Using Differential Audit Between Independent Network Audit Sources and all Clients, Servers, and Other Audit Sources to Discover Adversaries with Sufficient Control of Compromised Devices to Hide Their Activities.

In accordance with a further feature or aspect of the invention, differential auditing between independent network audit sources and all clients, servers, and so on is provided so that adversaries with control over compromised devices on a network to hide their activities are discoverable. For example, the network sees a number of data movements (e.g., data flow, data transmission, etc.), but the device audit omits one or more, either due to an adversary or another issue. Accordingly, it is unclear whether: 1) an error occurred; or 2) an active process was used by an adversary in control of a compromised device to hide the movement or transfer of a particular file or hide one or more commands, etc., from the device audit.

Prior to the present invention, many experts in the security business have endeavored to use end station, router, switch, and server-generated statistics as a primary instrumentation of monitoring traffic flow. The challenges essentially converge down to knowing the precise numbers over a standard unit of time and a way to accommodate propagation delay, losses, insertions, replays, duplicates, and such on varying size infrastructures. The lowest common denominator for gathering the raw packet stats are via Simple Network Management Protocol (SNMP) from interface tables associated with network devices. Since SNMP is User Datagram Protocol (UDP), and further since there is no scheduling capability whereby a remote device can measure and record on fixed, known time intervals, the quest for statistics typically devolves quickly into requesting such information when wanted. However the requests may or may not ever reach the device, which may or may not respond in a predictable amount of time, and cannot record the time which the measurement, if any, was made, and may or may not be delivered to the requester. Accordingly, the “man-in-the-middle” detector of conventional solution is not reliable.

The above-described invention and the various features or aspects thereof provide full instrumentation of traffic between every device. Accordingly, the present invention provides an independent audit of flow (plus many other more discrete items), so the unpredictable/unresponsive/unreliable SNMP stats are no longer required to be primary. In accordance with the invention, the active monitor (e.g., active controller) is enabled to search for and find devices that have been compromised, are currently being compromised, and/or attempts are being made to compromise one or more devices, and detect an adversary which is in the process of attempting to hide its tracks by using differential analysis between the new accurate measurements and the less accurate measurements from the end devices. Thus, the system and method of the invention, including the central monitor/control, Active Monitor, or the like, learns which devices, nodes, hosts, networks, IoT devices, and so on, are reliable and which devices are not reliable, which devices belong to the network, and which devices do not, which devices, communications, packets, etc., are honest or legitimate, and which are not. If the network devices do not provide accurate logs or statistics, it may simply be the result of poor device design, incomplete software, buggy or poorly implemented devices, and/or other innocent or non-malicious devices that do not behave as expected. Because such a device is monitored for a long period of time according to the present disclosure, its unique set of errors will most likely be consistent. The machine learning algorithm of the active controller has the capacity to differentiate this type of consistent set of errors from an adversary. When an adversary obtains root control on a server and/or device and begins hiding its tracks, editing its audit records, etc., the differential audit feature or aspect of the invention can detect it in real-time. One or more central monitor/controllers, Active Monitors, or the like, implementing one or more of the above-described features, aspects, methods, algorithms, AI, and/or machine learning, and so on, constantly monitors each device, node, etc., of the network to establish a stable base of truth in communications, accurate to each packet and byte for all communications and all pairs. The differential audit preferably includes a method of spot-checking the audit records, SNMP stats, and other sources of logs and statistics from the end stations to discover gaps in the books which are signs of “cooking the books” or hiding an adversary's tracks, from a compromise on that node. Once a node is known to be compromised to actively cover its tracks, the present invention can employ one or more methods such as device swap-outs to ensure the compromised node is put out of service. In any event, the compromise of a device switches a binary marker from trusted to untrusted. Because a device that hides records of activities usually has something to hide, a device that fails to produce a portion or all of its records over a known time period may be marked as unreliable.

In reality, the decoders in the active device are far more detailed and nuanced than packet counters and byte counters. When the SSH connections inbound or outbound for a host are monitored, the present invention can determine that there is an ongoing established connection resulting from the connection attempt, and actively measure dynamic keep-alive signals, their frequency, their content/size, and how they vary over time. Over hundreds of protocols with thousands of primitives, the network monitor sees raw activity as well as subtle differences between hosts across all devices and all devices of the same type across all customers—with the express purpose of finding devices that behave differently from their peers as an indication of compromise. The machine learning algorithm enables this ability of detecting unexpected behaviors.

Using Standard Network Protocols to Prevent Unaudited and/or Uncontrolled Peer-to-Peer Communications Within Network

In accordance with a further feature or aspect of the invention, an overlay using standard network protocols can be used to prevent unaudited and/or uncontrolled peer-to-peer communications within the network. This overlay using standard network protocols is intended to fundamentally change the way networking is accomplished. Networking protocols are intended to keep traffic flows as local as possible, such that two devices on a subnetwork find shorter paths between each other to utilize shared networks, hubs, switches, or routers. in these cases, it allows largely unfettered lateral movement between devices with insufficient audit or control, sometimes the lateral movement is controlled by an adversary. Accordingly, a novel implementation of the present invention may block direct communications between every device on every subnetwork other than an audit/control/filter/isolation device.

This overlay method in accordance with the invention is unique in that every single device on the network is isolated/separated from all other devices for security and accounting purposes. Several attributes of the invention will now be described .

A first attribute or feature includes the separation of every device from every other device on the network by putting every device on a different port, so that the statistics are available for each port. As described above, witched ports are bridged together so that if any two devices want to communicate, they can communicate at Layer 2 (as described above) and are considered as local traffic. Where there are layers of switches, routers, and traffic monitors, local traffic (such as the two devices connected by the bridged switch ports at Layer 2) stays inside the one switch and is never seen outside, nor can effective controls be inserted into an existing switch to allow either extensive monitoring or selective traffic blocking for security purposes.

A second attribute or feature of the invention includes the provision of an overlay network to achieve the purpose of preventing unaudited peer-to-peer communications. This overlay network preferably includes a Layer 2 switch with VLAN tagging features. VLANs and IP subnetworks are conventionally deployed in groups, such that a number of devices share the same broadcast domain, the same IP subnetwork, and the same gateway. When they are deployed in this manner, the Layer 2 switch allows and encourages peer-to-peer direct connections along the shortest path inside one or more switches.

In accordance with a preferable exemplary implementation of the invention, every single port is put on a different VLAN from every other port. In this manner, the switch's VLAN treatment is to form infinite isolation between VLANs, such that no one device can directly communicate with any other device. In this case, no device can directly communicate with any other device, no server, desktop, user, firewall, router, guard, printer or IoT device because each has its own VLAN.

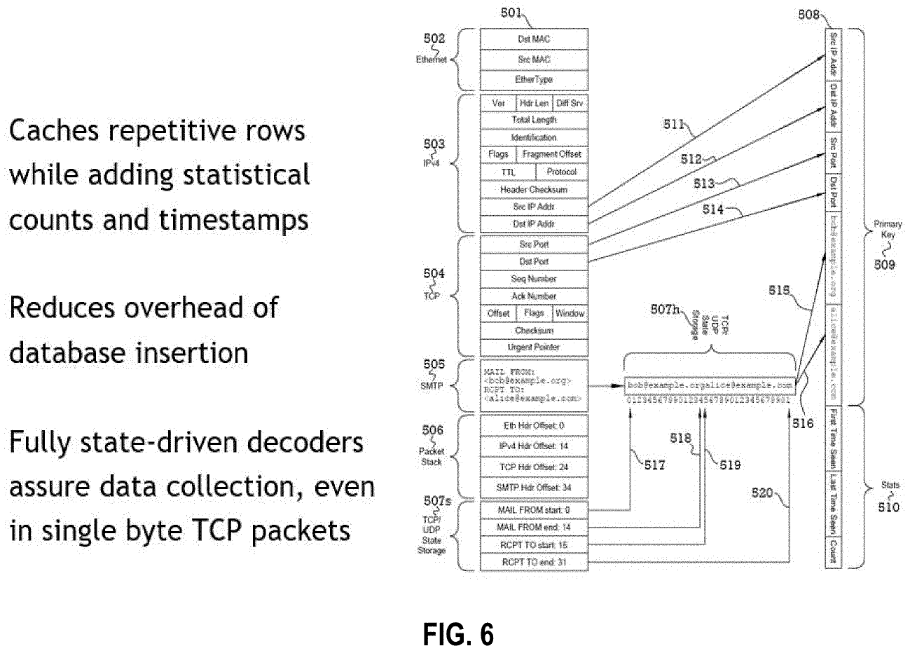

FIG. 6 is a schematic diagram of an accumulator used in conjunction with the active monitor/controller/filter as described herein with the filter data including data collected from all devices, networks, hosts, website addresses, approve lists, blocklists, ownership lists, location lists, data packet information, and so on, for efficient deployment of the present invention. The accumulator as illustrated in FIG. 6 can be same as those as disclosed in U.S. Pat. No. 8,472,449 and as discussed above and incorporated herein by reference. The accumulator may be utilized in conjunction with the methods and systems as described herein for recording packets and packet streams to random-access block-oriented recording media.

The present invention preferably comprises adding at least one wrapper to a network data packet to unambiguously mark all traffic to a physical source port of the packet, so that all attributes associated with a packet can also be attributed to a physical device and port. VLAN tagging in accordance with the invention is preferably accomplished at the physical port of each switch, so that the VLAN tag maps to port and thus all data in all packets are also unambiguously mapped to port. Preferably, every port is tagged with a different VLAN from every other port. one advantage of the present invention is that it only allows users on a network to communicate through monitored paths. The provision of tagging every port with a different VLAN from every other port is particularly advantageous from several standpoints and offers several unique benefits, as will be described below.

As shown in FIG. 3, a simplified example of VLAN tagging of data packets passing through different ports is shown, where for example Port 1 associated with a first packet is tagged with VLAN 1 (Labeled “Tag 1” in FIG. 3), Port 4 associated with a second packet is tagged with VLAN 4 (labeled “Tag 4”), Port 5 associated with a third packet is tagged with VLAN 5 (labeled “Tag 5”), and so on. The VLAN tagging of each port serves as the basis for positive attribution in a LAN. Every packet is labeled, tagged, or “tattooed” with the particular port through which each packet passes to connect with the network. This method of VLAN tagging in accordance with the invention thus serves as the basis for accurate mapping, accounting, attribution, and other security functions. To that end, the tagged packets shown in FIG. 3 for example, are preferably static, and therefore remain unchanged as long as the packet retains its integrity, to ensure the packets have not been compromised. However, it will be understood that variable VLAN or dynamic tagging can be used without departing from the spirit and scope of the invention, as long as each tagged packet is traceable to the port through which it entered the network.

A second VLAN tagging feature of the invention associated with the above-described VLAN overlay, enables every port to be put on a separate VLAN, thereby effectively breaking all switches (by turning off their switching/bridging function) that support VLANs, so that they can no longer switch local traffic directly between local ports, thereby disabling peer-to-peer communications within a firewall, enclave, etc. Therefore, the above-described hidden peer-to-peer breaches are prevented. In addition, the breaking of all switches prevents bad actors from mimicking one device or user on another port—thereby eliminating misattribution of which device is controlled by the bad actor.

Referring again to FIGS. 1 and 2, a third VLAN tagging feature in accordance with the invention is shown in FIG. 2, while conventional peer-to-peer communications is shown in FIG. 1. The fundamental change between FIG. 1 and FIG. 2 is that with the implement of FIG. 1, lateral communications behind a firewall or enclave are not monitored, where with the implement of FIG. 2, no device on any port is permitted to communicate laterally with any other local port on the switch directly. Instead, as shown in FIG. 2, all traffic is on a different VLAN from all other ports, enabling monitoring of all data inside an enclave by one or more central monitor(s)/controller(s) at all times to immediately disconnect the devices in the event it is determined at least one of the devices has been compromised, is a bad actor, attempted spoofing, and so on, as described above. Thus, one of the more salient features or purposes of the present invention comprises stopping, in real-time, the otherwise uncontrolled breaches once the attacker gets access to any one device in an enclave and then gains access to other devices in an enclave by lateral communications.

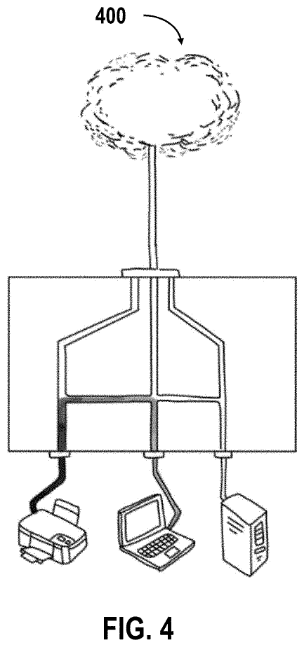

FIG. 4 shows lateral connections and unmonitored lateral data transfer between network devices in a conventional network 400. FIG. 5 schematically illustrates a network configuration 500 improved over the conventional network 400. In particular, independent vertical connections are isolated from each other in the improved network 500 by breaking lateral or peer-to-peer communications, so that all data and device information travels through an active monitor/controller/filter device to ensure only trusted devices and trusted data are allowed on the network. In this configuration, no device is permitted to communicate with other devices unless that communication is permitted by the active monitoring device or controller. The active Monitoring feature ensures that all network-wide communications or attempted communications are viewed by the active monitoring devices and controlled by the active controller(s), which are in turn dependent on one or more active filters that determine when predefined conditions indicative of a compromised device or the like have been met. Accordingly, the active controller of the invention is capable of disconnecting communications between two devices to thereby prevent malicious attacks, breaches, lost or stolen data, and so on.

In accordance with a fourth VLAN tagging feature of the invention, every non-trunked user port is assigned to a separate VLAN with only one user per VLAN (which is also one user per port). Since switches do not allow communications between users on different VLANs, this invention effectively isolates every device, thereby disabling direct communication with any other device. Instead, communications from one device to another are forced to pass one or more active devices (e.g., active controller) which monitor, control, and enable the transfer of packets between VLANs with or without routing. This is in sharp contrast to the conventional switches that normally function to provide quick and unmonitored and unfettered lateral communications between devices on a network. Accordingly, the conventional local switching allows an adversary to spread laterally to different devices on the network, a security deficiency of the conventional architecture of a network which switches groups of users together, where each local group is a broadcast domain and an IP subnetwork. These small groups of computers form a broadcast domain means for any broadcast message (like an ARP or DHCP request) that can be heard by everyone in their subnetwork—including their router which ties their broadcast domain to others like it. These broadcast domains are also called Layer 2 bridged groups, VLANs, or IP subnetworks. The use of relatively small groups of computers is advantageous over relatively large broadcast domains, as large domains become too noisy and quickly load up with too much one-to-all broadcasts (wasteful noise). Networks are subnetted so that the broadcast domains are kept to a workable size, such as to a floor in a building or to independent groups on a floor to maintain some security separation. Broadcast domains exist so that a device, such as a new computer deployment, can find all of the services it needs for bare functionality, and can then use a router to obtain access to the rest of the world (routers don't propagate broadcasts), such that broadcast discovery is not needed across huge groups. This can be compared to the practical matter of needing to discover a local printer on the same floor or two blocks away. Thus, the practicality of finding what is needed on a small local area network outweighs advantages gained by searching on a much larger group.

Among the many advantages associated with the present invention, one of the advantages is the elimination of security vulnerabilities and other undesirable baggage inherent with a local broadcast domain, a switched network and subnetwork where any device can talk to any other device locally with little, if any, security visibility and limited availability of controls. The present invention can be adapted with relatively simple, low-cost, yet thorough means for monitoring, controlling, filtering, and performing other functions with respect to every node, connection, data packet, device, and so on, to ensure that all devices on a network are secured and shielded from all other devices, adversaries, attempted breaches, etc., in real-time and with relatively small storage requirements

In some cases, when Layer 2 subnets are shrunk down to just one server, client, or device, many of the critical underlying protocols necessary for a network to function may not function well when fully isolated and no longer on a broadcast/open local domain. The three most basic functions associated with moving to one VLAN per port per device include DHCP, ARP, and communicating with the router. On the network, natively no other nodes can be communicated with, no reachable DHCP server, an IP address is never assigned (unless statically assigned by hand), ARP may not function because the broadcast ARP request is not heard, and the server, client, or device is not permitted communicate with the router because these devices are not on the same VLAN.

In order to successfully implement the present invention on a single server, client, or device, the challenges of preserving the DHCP and ARP functions, as well as preventing other broadcast message protocols from breaking when one VLAN per device is implemented, as further discussed below.

In accordance with a further embodiment, feature, and/or aspect of the invention, improvements to VLAN bridging/switching are described. In switches and bridges, devices on the same VLAN can communicate with each other but devices on different VLANs cannot. When devices on two VLANs need to communicate, the conventional solution requires that communicated packets need to be routed by routers. However, since the security solutions of the present invention define one VLAN per port minimum and one VLAN per end device MAC address, the number of VLANs may require as many router ports and subnetworks as there are devices on a network, may be desirable as described herein for new installations, the provision of large numbers of devices may most likely not be the best design for a retrofit or commercial offering leveraging current switch technology.

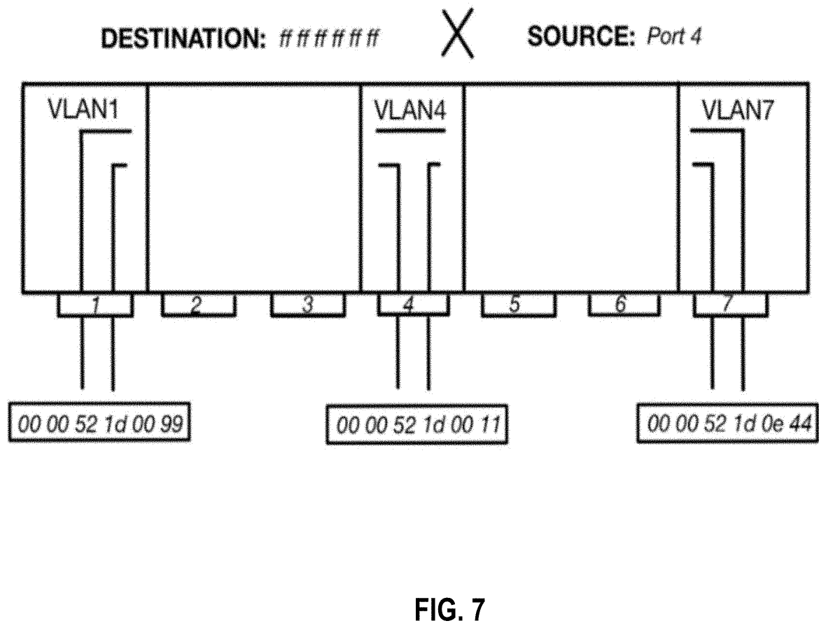

As shown in FIG. 7, if a device 00 00 52 1d 00 99 on Vlan1 on port 1 wants to communicate with the device 00 00 52 ld 00 11 on VLAN4 on port 4, the VLAN tags on all packets may be changed. Further, since the invention includes the use of separate VLAN tags for each device to create traceability and isolation so that the actions of every device are auditable as described above, the VLAN tags wrapping every packet are different from every device on the network. In such cases, every communication requires the network controller to change the VLAN tags on every single packet. Since it is impractical to place a router on every port of every switch for retrofits and compatibility with current switches and routers, a system and method for creating communication links between devices with different VLAN tags in a network controller in accordance with a further embodiment of the invention will now be described.

With respect to the present embodiment of the invention, the capability to create communication links between different VLAN tagged devices preferably employs techniques described in the U.S. Pat. No. 8,291,058 ('058 patent) issued on Oct. 15, 2012 and entitled “High Speed Network Data Extractor” (HSNDE), as previously referenced, in several unique ways as follows:

1. The HSNDE enables much larger IP and domains lists.

2. The HSNDE enables lookups at line rate on these large lists.

3. The HSNDE enables blocking or passing in real-time with both large lists and high throughput links.

4. The HSNDE provides tagging recognition, statistics, accounting, making and logging of block or pass decisions, seeing mismatches from expected values for each port and device, and providing real-time lookup of translation tables for VLAN switching or higher protocol switching as needed.

5. The HSNDE enables real-time VLAN switching whereby packets are both bridged and re-tagged to a new VLAN in each direction for each packet as described for security.

Conventional filtering firewalls typically have blocklists of tens of thousands but do not have the ability to handle even a one-million-entry blocklists or approve lists to date. The problem is that the size limits for filter lists are significantly below current network security filtering size requirements. This is because there are 4.3 billion IPV4 IP addresses, of which approximately 3.7 billion are publicly routable. In addition, about 1 billion IPV6 addresses are currently in use. Accordingly, it is currently anticipated that the present invention can support IPV4 and IPV6 black and approve lists of about 8.5 billion entries but this will grow significantly over time. The above features or aspects of the present embodiment of the invention will now be described in further detail.

In order to make block/pass decisions based on current internet requirements, and employing the teachings of the '058 patent, methods and systems are provided to utilize lists, in accordance with the invention, including all registered IPV4 addresses and all registered IPV6 addresses as block/pass tables. For domain names, the accumulators described in the '058 patent are leveraged to use a novel way to store all registered domains and all known hostnames in use. This allows a block/pass for each domain name and hostname/fully qualified domain name (FQDN) as well as recognizing new domains in real-time (by storing all known and registered domains in memory, new domains are recognized as new in real-time).

The present invention supplements or extends the teachings and solutions of the '058 patent by including qualified actions that move beyond packet decoding and conditional logic branching in decoding and recording to include the following new qualified actions:

Import reference pass and blocklists as well as ownership, geolocation, history, and reputation for IPs and fully qualified domain names so that these attributes are available to enrich and qualify traffic in real-time.

Incorporate lookups of reference data in real-time enrichment. These lookups are external and could be slow at the first time of the lookup, but subsequent lookups will be at ultrafast speeds. Due to the repetitive nature of network traffic and the relatively long time for setup of an initial IP or non-IP network connection, the implementation provides very fast filtering and forwarding operations using immense reference lists.

In accordance with the invention, when a row is created for the first time in a packet, the enrichment data is resolved. This can be implemented by any suitable software programming language compatible with network functions, and/or programmable databases, including but not limited to, C++, RocksDB, Oracle, SQL, JudyArray, and the like.

Next, qualified actions are evaluated to determine whether they contain any enrichment data.

For qualified actions that contain enrichment data, the qualified action along with the enrichment is cached along with the row in the accumulator.

On subsequent packets, the matching row is found in the accumulator and the cached result of the qualified action from the first row is used as the evaluation result of the current packet. In accordance with the invention, rows can be found by taking all of the required items in a task, then hash them. The hash is the used to find the prior results of matching rows.

Lookups are allowed at line rate on these large lists. The present invention can be used in conjunction with the accumulator method, as described above, in the '058 patent, by enabling an extension of the method to enrich data and look up reputation, history, geolocation, ownership, associations on all communicants, and so on, rather than performing only high-speed decodes. The nature of the accumulator is that the enrichment results for each row are cached for all subsequent rows, since a row is indexed by a hash value encompassing all required fields in the data. Since most network data is in the form of multi-packets that may have a relatively long life, this method in accordance with the invention greatly reduces lookups and puts the results in the accumulator (described in the '058 patent, for example) for subsequent decodes that reach the same specified branch in the protocol tree with the same selectors presented in traffic.

Blocking or passing of data are allowed in real-time with both large lists and high throughput links.

In accordance with yet a further embodiment of the invention, a series of qualified actions are implemented in the accumulator described in the '058 patent. Rather than merely parsing and recording data from the packet or history of a related packet stream, this embodiment of the invention enables modification of the packet flow, preferably starting with the following exemplary qualified actions: a) Pass the packet; b) block the packet; c) modify the packet (e.g. change VLAN tag); d) change the source or destination MAC address; e) change the source or destination IP address; f) encode data in one or more fields; and g) delete or change data in the packet or data stream.

A more extensive set of qualified actions in accordance with the invention include “save for investigation” actions of many types. In cases of violation of law, theft of data, compromise of systems, etc. one such qualified action is merely to keep all traffic recorded before, during, and after an event. In basic operational mode, the device can be setup to record at all times, which then gives the user a long period of time before the oldest records are overwritten. By using qualified actions, a trigger not only records packets after an event was detected, but before the event as well, by reaching back and saving packets that were recorded hours, days, or months before any event.

Furthermore, the present invention, enables tagging recognition, statistics, accounting, making and logging of block or pass decisions, seeing mismatches from expected values for each port and device, and provides real-time lookup of translation tables for VLAN switching or higher protocol switching as needed. This invention enables independent tagging of packets, wherein the VLAN tag originates on each individual switch port, WiFi device, or other control point—where every VLAN tag is unique and not shared with another device or port on the Layer 2 domain. In this manner, no spoofing by the end device can remain undetected, as the VLAN tag is written over or created by the switch port, WiFi device, or other control point which is outside of the device being monitored. The Active Monitor of the invention provides protocol decodes and provides a way to inspect and correlate every nominative in traffic to the device and port. If a source address is spoofed or forged, the traffic is reported and blocked. If a user logs in from another person's machine, this is logged and used for security audit and can be recorded, blocked, or other actions taken. Since VLANs are currently defined as a 12-bit VLAN tag, a maximum of 4096 VLANs tags can be implemented.

An active controller can be adaptive to supporting a network of any suitable size such as up to 4096 ports or devices. For example, when there is only one MAC address/device on each port, the protected network may have up to 4096 ports, but since WiFi devices are also tagged with one VLAN per attached device, the present invention preferably includes providing one active controller that can separate traffic from 4096 devices. In this manner, the limit is device count rather than port count. The network size is not limited to 4096 devices. For example, an active controller can have multiple physical interfaces, each with up to 4096 VLANs on each physical interface. Thus, a huge campus could have many more than 4096 IP addresses on a single IP subnetwork and still be switched securely using the active controllers provided by the present invention. In accordance with a further embodiment, the IP subnetwork size can be independent of the number of devices on a switched, secured, and monitored network. Moreover, the size of the IP network and the switched networks interconnected to active controllers are largely independent decisions and can therefore greatly vary.

In accordance with an exemplary implementation of the invention, multiple active controllers can be distributed around a building, campus, area, or globally—each may include one or more groups of 4096 devices.

Moreover, IP routing can be done by external, traditional routers independent of the per-device and per-port control and monitoring described in herein in accordance with the invention, to thereby preserve the legacy network's setup. Alternatively or additionally, the active controller can perform as a Layer 3 switch by enabling routing on a per-port and per-device basis. At a low level, this is may be accomplished by changing the source MAC address for any or every port to be a router. The Layer 3 switch routing is preferably used as a basis in implementing the invention related to segregation and different techniques and/or methods for exceeding the 4096 VLAN limit while creating a zone of trust and offering some options to encode and include inherited contextual data between active controllers, as discussed below.

When many Layer 2 domains and active controllers are added to a campus or global network, the Active Monitor can insert trust, origination, authentication, and other data which is used by the remote Active Monitor to put the incoming communications in context globally. This data can include, but is not limited to, a combination of in-band, in-traffic, out of band, out of traffic, central authority reference data, and can be transmitted via any convenient channel, field, or method. For example, the sender's reputation and identity can be embedded in either a source MAC address wrapped in a Virtual Private Network (VPN), and/or any other encapsulation method. The sender's reputation and identity and/or other pertinent information related to trust/not trust decision-making, can be embedded as a Source IPV6 IP address sent alone or wrapped in a VPN, or any other encapsulation method, as well as any suitable method for embedding the sender's information with sufficient detail to enable an automated trust/no trust decision as part of a machine learning algorithm or AI routine.

In accordance with an exemplary embodiment of the invention, the entire array of qualified actions (or preselected portion(s) thereof), including any set-up lookups, filters, forwarding, and tagging decisions need only be made once for any repetitive packets by using accumulators in accordance with the '058 patent, where all of the reference data, decisions, and field insertions/deletions/modifications are cached for subsequent packets having the same selectors. This makes bridging, routing, encapsulation, filtering, forwarding, blocking, and other intensive computations unnecessary for subsequent traffic (e.g., packets).

The above-described embodiment can perhaps be better understood when put in the context of communications between two active controllers on a single interface and channel. It is known that source IP addresses and source MAC addresses cannot be used to transmit data without breaking the ability for the distant device to reply (since the source address is not the real one). In accordance with the invention, the source MAC address is preferably tied to the source VLAN and the inter-active controller traffic is likewise known, as it came from the other active controller on a single interface and channel. Accordingly, the real source MAC address can be embedded in a synthetic IPV6 source address along with additional data passed between Active Monitors. Thus, there are a variety of options ranging from a global lookup service, an enterprise lookup service, along with in-band signaling by which two active controllers can share data for the purpose of monitoring, sharing common primitives of trust, common actions, and local knowledge.

Furthermore, the invention preferably provides real-time VLAN switching whereby packets are both bridged and re-tagged to a new VLAN in each direction for each packet as described for security in a related patent description. This invention further sets forth a unique, non-standard method of putting each device on each port on a different VLAN from all other ports on a local network. Thus, for any two devices to communicate, they cannot use the unmonitored Layer 2 switched infrastructure. Accordingly, attempts to propagate breaches laterally between a compromised device and other devices in the LAN (e.g., within an internal network or in an enclave) may be observed and prevented.

The Active Monitor in accordance with the invention as described throughout the specification can be modified, in accordance with a further embodiment of the invention, to remove the VLAN tag of the sender and replace it with the VLAN tag of the receiver (e.g., the port or device at the destination through which the packet passes). Preferably, VLAN retagging takes place for every packet because devices are on separate VLANs according to one aspect of the present invention. As with other high-level switching and routing features, VLAN tagging as described above, any set up lookups, filters, forwarding, and tagging decisions need only be made once for any repetitive packets by using the '058 accumulators in this new method of VLAN tagging and retagging. Note that the VLAN translation tagging is direct within the zone of a local active controller when using VLAN tags alone for a maximum of 4096 devices. Direct mapping for a larger campus or global network will likely use specialized source MAC addresses or source IPV6 addresses encapsulated in a protocol wrapper, VPN tunnel, or other encapsulation method for larger or global networks. Since the method already performs lookups in tables of size in the billions, direct mapping and transfer of credentials and measures of trust can use in-flow credentials put in at the source network's active controllers or shared by network lookup services.

With respect to Legacy and potential vendor-dependent VLAN implementation, it is not always possible to only bridge between VLANs (and even though routing is a solution in accordance with the invention that works). Bridging and VLAN switching using legacy hardware in accordance with the invention offers several advantages. A reading of the relevant RFCs can result in conclusion that duplicate MAC addresses on different VLANs is not allowed, while some switches allow duplicate MAC addresses on different VLANs. This invention therefore addresses a novel solution for using switches that do not allow duplicate MAC addresses on different VLANs, as described below.

Referring now to FIG. 7, a schematic diagram is shown, showing different VLAN labels associated with different VLAN ports. If device 00 00 52 ld 00 99 on Vlan1 on port 1 requests to communicate with the device shown on VLAN4—one technique is to issue a command to “bridge it to VLAN4”. However, some VLAN switch implementations are designed to not allow this. Not only will a conventional switch not allow devices on different VLANs to communicate with each other as a security design principle, doing so with an external bridging device may or may not create spanning tree faults and sporadic outages on the network—because some VLAN switches may not allow the same MAC to be associated with two VLANs.

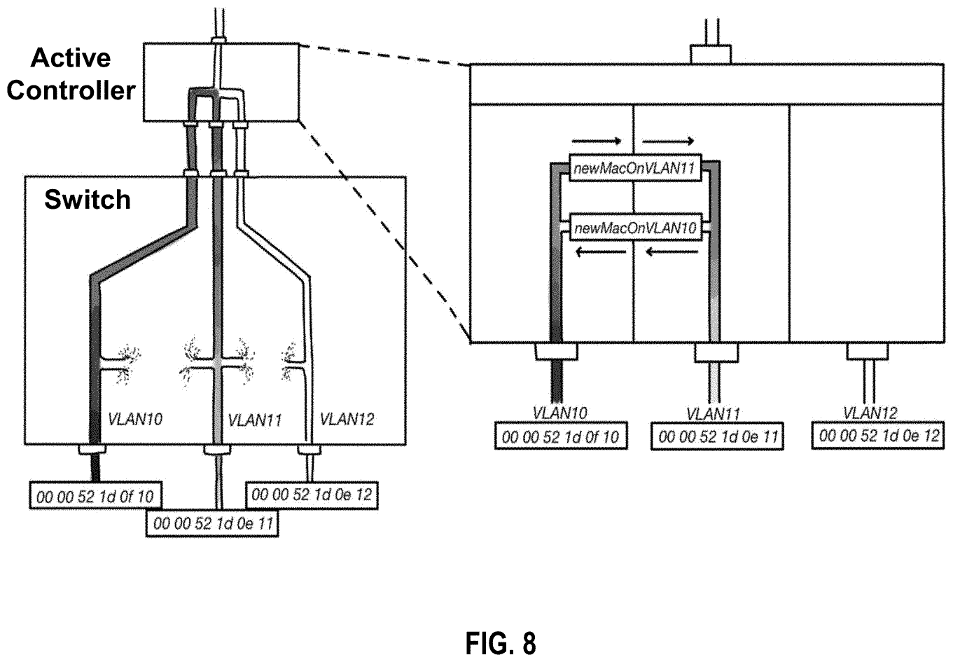

Turning now to FIG. 8, and in accordance with a further embodiment of the invention, the above-described problems are overcome by the provision of several improvements over the conventional solutions to thereby allow controlled communications between devices isolated to different VLANs without routing. Since each MAC address can only be on one VLAN, virtual MAC addresses are introduced on every port with no more than one virtual MAC address for each communicating MAC address pair (often less, with only one virtual mac per port). The “virtual MAC addresses” do not refer to real end devices, but rather virtual devices as they exist virtually in the network switch gear. However, in virtually all respects, they are actual MAC addresses that can be registered local or generated. The only requirement is that they are unique on all interconnected bridged subnetworks. This uniqueness does not apply across other networks separated by one or more routers.

As shown in FIG. 8, MAC Address “00 00 52 ld 0f 10, which is labeled [10]” on VLAN 10 cannot communicate with “00 00 52 ld 0e 11 [11]” on VLAN 11 because VLANs only allow communications between devices on the same VLAN. Moreover, a MAC address cannot be a member of both VLANs. Accordingly, the present invention introduces a new pseudo MAC address where one new pseudo MAC address is introduced in each direction. Thus, when [10] sends a packet to [11], the packet is bridged to a new pseudo MAC address, which is mapped to VLAN 11 on port 11. In the return direction, [11] knows [10] as the pseudo mac address, which then forwards any responses via a pseudo MAC address on VLAN 10 back to [10]. For a Layer 2 network with M unique Mac addresses and N VLANs, the number of pseudo MAC addresses required is M times N.

The following description of the Proxy MAC method for legacy switches in accordance with the invention is described, beginning with a definition of some key terms as follows:

Port—In this case a physical Ethernet Interface on the Security Device or Switch;

RC MAC—The Source MAC Address;

DST MAC—The Destination MAC Address;

Real MAC—The MAC Address assigned to a specific port of a computer;

Alias MAC—A MAC Address assigned to a Real MAC when traveling in a foreign Path;

Path—A communication segment between a switch VLAN to Security Device; and

VLAN Range—A range of VLAN ID's that are assigned to a specific Security Device Port (Interface). For example, 101-201 assigns all VLAN IDs from 101 up to and including 201.

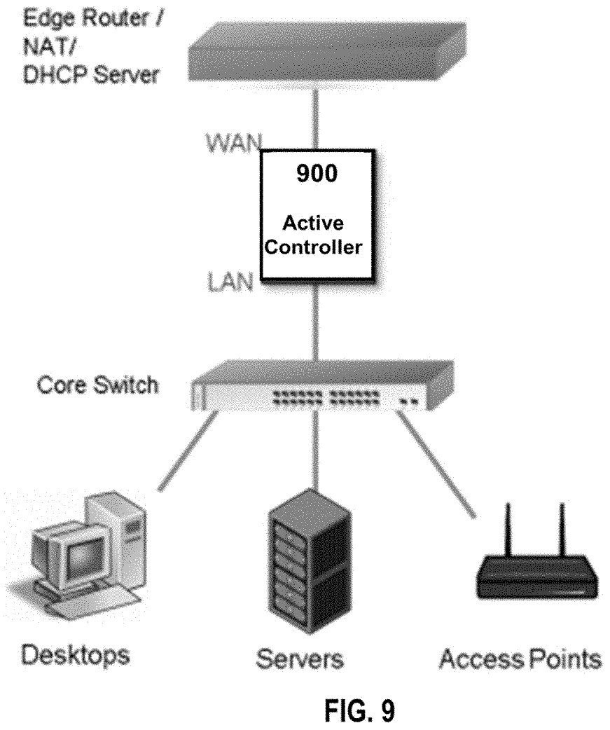

FIG. 9 shows an example of an active monitoring device or controller 900, as deployed in a customer's network to thereby isolate the devices and data on the network from each other, and continuously monitor and control connection between devices and transfer of data into the network, out of the network, and laterally within the network and only connected when monitored devices and data are trusted. A network system may be equipped with one or more active monitoring device or controller for creating and securing a network as described elsewhere herein. The active monitoring device may also be referred to as security device.

In some embodiments, the active controller 900 may be positioned between the Router/NAT/DHCP Server and the core switch, with WLAN and LAN connections therebetween, respectively. The active controller 900 can be the same as the plug-and-play devices as described above. For example, the security device can be configured to received traffic between the monitored network device and the network such that all traffic to and from the network device is monitored. Other devices such as desktops, servers, access points, and so on, are shown connected to the core switch.

Placement of the active controller of the invention within customer premises is preferably inside the firewall (or any Network Address Translation (NAT) device) between the firewall and the core switch—but it can be placed anywhere inline. The active controller may have two physical Ethernet ports designated WAN and LAN to denote inbound and outbound directionality, although these ports are effectively bridged. In some embodiments, the WAN side is placed toward the firewall with Internet access, and the LAN side is placed toward the rest of the internal network. As an example, the active controller may be connected to a network device via wired connection (e.g., WAN cable) and connected to the switch via wired connection (e.g., LAN cable).

The security device may comprise one or more processors to implement various functions as described elsewhere herein. For example, the active controller may comprise one or more advanced RISC machine (ARM), single or multiple microprocessors, field programmable gate arrays (FPGAs), capable of executing particular sets of instructions, and an internal HBM memory system for storing data structures such as flow tables and other analytics and providing buffering resources for advanced features including packet inspection, storage offloads, and connected FPGA functions. Alternatively or additionally, the active controller can be implemented in hardware components (e.g., ASICs, special purpose computers, ARM, FPGA, or general-purpose computers), software or combinations of hardware and software.

In order to prevent lateral movement of malicious code (e.g. movement from computer in the LAN to another), the security device/Switch combination (e.g., active controller) assures that all packets between any two computers or other network devices flow through the security device for inspection. This can be accomplished using VLAN Translation, as previously described or alternative methods of tagging or selective blocking based on any observable of each packet or flow. These methods can be used with or without MAC translation as.

Normally, a network switch operating under conventional connections, may allow two computers to directly communicate with each other through the switch, as illustrated in FIG. 1, as previously described. This “normal” switch behavior may be changed to meet the requirements of the present invention to direct all packet flow through the active controller. As shown in FIG. 2, and as previously described, the schematic representation of isolated vertical lines (communication path) or broken lateral lines (communication path) shows the direct lines breaking, and the insertion of a security device appliance between the switch and Internet.

With the broken lateral communication lines for switches, the Layer 2 bridging no longer works because a different VLAN tag is assigned on every port. Since no two ports are on the same VLAN, hardware will ensure that no networked devices can communicate within the configured switch. The broken network, in accordance with an exemplary embodiment of the invention, can include up to 4096 devices on up to 4096 ports (or virtual ports) which cannot communicate with each other apart from going through the active controller of the security device, which in turn creates audit records as well as enables blocking or passing each packet of data based on security decisions as previously described.

In this manner, every packet sent by every device in the network is monitored by the active controller of the security device. The security device may then determine whether to allow the two devices to communicate and either passes the flow of data or blocks it based on the determination.

This VLAN tagging also indelibly brands each packet transmitted with the VLAN tag uniquely assigned to each port, such that no two ports on a monitored network have the same VLAN tag. In this manner, total isolation and total loss of anonymity of every device, packet, node, and so on, associated with a network is enabled by the present invention. Thus, every packet sent into each port is kept separate and therefore can be analyzed separately with the VLAN tag intact by an active controller.

If device 00 00 52 ld 00 99 on VLAN1 on port 1 wants to communicate with the device shown on VLAN4—a command to “bridge it to VLAN4” will not work for many VLANs. But VLANs are designed to NOT allow this. Not only will a switch not allow devices on different VLANs to communicate with each other as a security design principle, doing so with an external bridging device creates spanning tree faults and sporadic outages on the network, since VLAN switches do not allow the same MAC to be associated with two VLANs. If it is attempted, all kinds of spanning tree faults occur. The novel solution to this problem in accordance with the invention is described below, in conjunction with FIG. 8.

In the expanded view of FIG. 8, a novel improvement in accordance with the invention allows controlled communications between devices isolated to different VLANs without Layer 3 routing. Since each MAC address can only be on one VLAN, Alias MAC addresses are introduced, with not more than one Alias MAC address for each communication path. MAC Address 00 00 52 ld 0f 10 which is called [10] on VLAN 10 cannot communicate with 00 00 52 ld 0e 11 [11] on VLAN 11 because VLANs only allow communications between devices on the same VLAN. Nor can either MAC address be a member of both VLANs.

Thus, the present invention introduces an Alias MAC address where one new Alias MAC address is introduced in each path. Note that FIG. 8 shows that two paths are required to complete an end-to-end communication. By way of example, pathl is from [10] to Security Device, and path2 is from Security Device to [11]. Also, two Alias MAC addresses are required for VLAN to VLAN communications. MAC Address [10] may have an Alias when traveling on path2, and [11] may have an Alias when traveling on pathl. Further, [10] never knows the true identity of [11], and [11] never knows the true identify of [10]. But the Security Device, which includes an active monitoring/control device, knows the Real MAC and Alias MAC pairing of every computer in the network. The Security Device of the invention is responsible for performing translation between Real and Alias addresses when moving a packet between paths.

For a Layer 2 network with M unique MAC addresses and N unique VLANs, the number of Alias MAC addresses required is M times N.

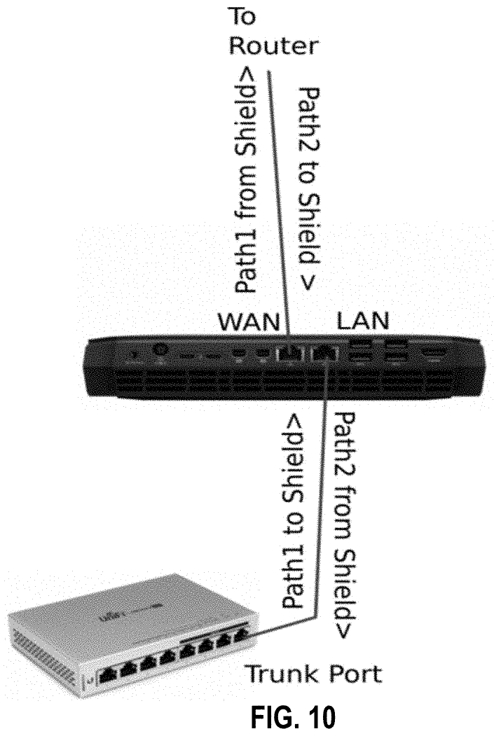

Referring to FIG. 10, although VLAN to VLAN communications have been described, there are actually four (4) modes of communication in the MAC Translation scheme, namely:

VLAN to VLAN

VLAN to no VLAN

no VLAN to VLAN

no VLAN to no VLAN

MAC Translation Modes of Operation

| | Path1 to | Path1 From | Path2 to | Path2 From |
|---|---|---|---|---|
| | Active | Active | Active | Active |
| Mode | Controller | Controller | Controller | Controller |
| VLAN to | SRC = Real, | SRC = Alias, | SRC = Real, | SRC = Alias, |
| VLAN | DST = Alias | DST = Real | DST = Alias | DST = Real |
| VLAN to | SRC = Real, | SRC = Real, | SRC = Real, | SRC = Alias, |
| no VLAN | DST = Alias | DST = Real | DST = Real | DST = Real |
| no VLAN | SRC = Real, | SRC = Alias, | SRC = Real, | SRC = Real, |
| to VLAN | DST = Real | DST = Real | DST = Alias | DST = Real |
| no VLAN | SRC = Real, | SRC = Real, | SRC = Real, | SRC = Real, |
| to no VLAN | DST = Real | DST = Real | DST = Real | DST = Real |

The last mode is the one normally used in Ethernet networks when no VLANs are present. The table below illustrates when Alias MAC addresses are required.

The table points out two important features of MAC Translation which are used in the implementation described later.

The SRC MAC is always the Real MAC when traveling towards the Active Controller. The DST MAC is always the Real MAC when traveling away from the Active Controller. The table below shows the resulting translation matrix for SRC and MAC addresses.

MAC Translation for Ingress to Egress

| Mode | SRC MAC translation | DST MAC translation |
|---|---|---|
| VLAN to VLAN | Real to Alias | Alias to Real |
| VLAN to no VLAN | Real to Real | Alias to Real |
| no VLAN to VLAN | Real to Alias | Real to Real |
| no VLAN to no VLAN | Real to Real | Real to Real |

Again, note that ingress SRC MAC addresses are always Real, and egress DST MAC addresses are always Real.

The use of proxy MAC addresses, as described above, is one preferable method for enabling communication between two VLAN devices, other methods, systems, and/or devices, as well as combinations thereof, are described below.

When broadcast messages are received by the active controller, these broadcast messages are replicated and transmitted to each VLAN in the broadcast group (which can be defined to include all or any subset of VLANs). This invention greatly reduces the replication of network services across multiple VLANs. Further, the active controller can be adapted for use with “smart ARP”, “smart DHCP”, as well as other very tightly controlled ARP (Address Resolution Protocol) for critical network devices. ARP spoofing is commonly used to compromise conventional network monitoring devices, thereby creating man-in-the-middle scenarios where all traffic is routed through the conventional monitoring device. The problem is that this malicious tactic works very easily, is not normally detected, and could not be stopped by conventional solutions

In fact, ARP spoofing enables the same malicious attack to be executed from any device to redirect network traffic through itself: allowing a device to monitor or spy on network traffic that mayn't otherwise pass by the spy's node. Worse, the spy's node can modify or inject traffic at will in a manner which is non-attributable to itself—a major new threat vector which allows an adversary to mask illicit activity. DHCP spoofing is another related trick, where a device answers DHCP requests with a network overlay rather than the native IP addresses of the host network. This also creates a man-in-the-middle attack where the rogue DHCP server inserts the selected device into the traffic flow, enabling monitoring or espionage, traffic modification, or insertion of spoofed traffic which may point an adversaries' attacks to an innocent third party. This rogue or overlay network routes the diverted traffic back to the native network to achieve external connectivity—so all connections on the network appear to work normally but in fact compromised.

In accordance with a further embodiment of the invention, the above-described ARP spoofing attacks are both monitored and prevented, as well as many other attacks. If a device responds to an ARP request for another device or if a device attempts to provide rogue DHCP services on a network, these are detected and blocked by the Security Device of the invention. Since the one VLAN per port in accordance with the invention isolates, encapsulates, and tags all packets with a network-inserted wrapper—all spoofing is detectable by the active controller. Networks have expected baseline behavior but are very tolerant of faults and changes, such as when somebody moves a computer from one wall plug to another or changes their IP address by overriding the DHCP or otherwise assigned identities. In any event, the invention fully attributes these changes to the port, the device, the MAC address, the packet forensic signatures at all protocols and options, by virtue of the fact that full forensic decodes of all traffic are done by a very much more capable central controller than can be done in a relatively low-cost switch. Further, since the ARP spoofing is not on the end device, the forensic trail is outside the administrative domain of the attacker.

One of the current industry terms is zero trust, where all devices inside or outside an enclave are treated with the same trust—in other words, a device is not trusted simply because it is inside the network. Inversely, if a trusted device is located in a foreign country that has exhibited hostility or has been known to operate covertly in an attempt to steal trade secrets, government records, and so on, it is blindly trusted because of cryptographic identification and other supposedly secure steps. To address this problem, the present invention provides the visibility to understand when a trusted device should be switched from a trusted to untrusted status upon observed questionable behavior.

In accordance with a preferable embodiment of the invention, full or absolute attribution is achieved down to the packet level by removing from the equation the physical implementation of devices, data links, networks, application layer spoofing, and anything else that may compromise or inhibit full attribution, to thereby enable total monitoring and complete control over every device, data packet, lateral communication between devices associated with a network inside an enclave, firewall, or other protected boundary, as well as monitoring and controlling traffic into and out of the network, and providing reliable auditing of all events before, during, and after such events to thereby detect and stop attempted breaches, spoofing, and so on. With the present invention, full attribution is achieved to monitor who or what did anything and everything down to the packet level. Accordingly, no spoofing, misattribution or other nefarious behavior can occur with the invention, because the network transport devices are fundamentally changed to remove uncertainty about who did what.

When automatically assigning IP addresses devices prior to gaining online access by the DHCP server, breaches may occur. The DHCP server will begin to assign its own range of IP addresses in competition with the actual intended enterprise DHCP server which are either: a) not compatible, or b) not guaranteed to be non-duplicative with the corporate internet—thus the more devices it configures, the more devices disappear from the network and are unreachable and unable to reach key resources themselves.

In order to address this recurrent problem, the present invention preferably includes providing one or more active monitors/controls/filters, and so on, with software-deployed analysis (e.g., machine learning algorithm) to tightly monitor all packets on all protocols from all ports all the time. The monitor/controller, as previously discussed, has the ability to control, modify, block, delete, and selectively filter all packets and all flows. In this manner, ARP spoofing and rogue DHCP servers are recognized and not allowed to interfere with proper network operations.

IoT devices, such as web-controlled light switches, baby monitors, security cameras, thermostats, modern appliances such as refrigerators and coffee pots, and so on, have different levels of security, while other such devices have no security at all. Thus, the weakest link in the network employing conventional security solutions, will quickly be discovered and targeted by a shrewd cybercriminal to gain access to data.

As discussed above, the present invention monitors all devices, even the weakest IoT link with little to no security features to determine whether unusual behavior is occurring, data uploads are being requested, spoofing is being attempted, and so on, then cuts off a device well prior to the possibility of a data breach, as well as auditing, recording, and storing any and all occurrences, activities, and so on. In this manner, not only is the attempted cyberattack monitored, recognized, and shut down in real time, the adversary is more easily exposed, traced, and identified

It will be understood that although the invention and various embodiments, aspects, and features thereof have been described in conjunction with VLAN tagging that enables each device to have a unique identifier , other means for isolating and tagging devices, data packets, can be provided without departing from the spirit and scope of the invention. A couple of exemplary embodiments of such means are briefly described below

Thus, in accordance with another embodiment of the invention, IP subnetwork masks are first set up such that every device is the only device on its subnetwork. The smallest usable subnetwork currently includes four (4) IP addresses of which two are usable for devices. So, for a private IPV4 Class A like 10.0.0.0/8, a secure network can comprise, for example, four (4) million devices with each device being isolated from all other devices on an IP subnetwork (by way of example only, using a/30 network mask with 4 IPs per subnetwork leaves a broadcast address, a default gateway, a user IP and one spare). For IPV6, it is anticipated that the potential number of devices, in accordance with the invention, is much more scalable by using a registered IP space and making each device's IP globally routable and globally unique, while each IP device is isolated on a subnetwork.

The IPV4 and IPV6 subnetworking approach is more scalable than the VLAN solution because the Layer 2 networks can be made larger with IP subnetting than with VLAN-based subnetting. A single IPV6 /32 netblock, for example, could be used for creating a closed community of zero trust globally through global use of the various inventions, embodiments, features, aspects, solutions, and so on, of the invention. At the local level, every device could be on a 4-address subnetwork, which could scale to a global network of allocated IPV6 addresses to create global isolation of every IP device from every other device. Additionally, the port level filtering done with VLAN filters can be accomplished with IP filtering just as effectively and accelerated with hardware or CPU optimization as well. This may enable Internet Protocol Security (IPSEC) for virtually everyone and permit global source shorthand notation using IPV6 source addresses for each unique tag identifier.

In accordance with yet a further embodiment of the invention, port-level isolation by encryption can be used for tagging every device. With this method, every device can be rendered isolated by encrypting each packet with a key associated with that device, such that if it is ever delivered around the active filter, it will not be decryptable, and thus not effective.

### Detecting, Deterring, and Limiting Ability to Insert Forged Traffic Between Devices on a Network

Open SSL or IPSEC at the switch level or down at the port or device level can be used to ensure that the packets tagged at a switch have not been modified or inserted in transit. Since the inventions and related embodiments described are designed to authenticate devices at the port level and log all MAC and IP addresses, users, identities, communications, conversations, beacons, lookups, delegations, forgeries, spoofs, and relationships all the time on all ports, the network would be able to assure that any device on the other side of the world was known to be at a certain place at a certain time with a known history. Further, historical behavior and trust can be established with these methods in accordance with the invention between distributed groups of users.

In some cases, the devices and methods of the invention may be deployed to a network where modern switches are utilized. Many modern switches support one MAC source address on multiple VLANs, such as up to 4096 VLAN tags on an active controller. The maximum number of VLAN tags can be greater than 4096.This is because the Tag Protocol Identifier (TPI) is currently set to 16 bits and 4096 in binary is represented by [0001000000000000]. With the theoretical allocation of the entire 16 bits, the limit could potentially be 65,535 VLAN tags, as the 16-bit binary representation is [1111111111111111]. However, the IEEE 802.1Q specifies the maximum number of VLANs on a single Ethernet is 4,096 (including all reserved VLANs) since only the 12-bit VID field is available, minus reserved end values of 0 and 4,096. Accordingly, although a single Ethernet could contain a much higher number of tags, in reality the actual number is 4094 different subinterfaces for an equal number of VLAN tags, which is still adequate for as many implementations of the invention.

For larger implementations, and in accordance with a further embodiment of the invention, the 4096 VLAN tags (including all reserved VLANs) can be extended to build much larger trust networks. First and most obviously, with current switch technology and international standards, the maximum number of 4096 subinterfaces is standard, although it will be understood that the present invention can be used with switches that may have increased space, such as 32-bit or 64-bit devices for example. Until then, the world can be divided into groups of 4096 devices on each active controller and these active controllers can be routed or bridged to each other, to thereby provide a plurality of active controllers that each independently function in their own sphere, while coordinating through a primary central controller so that common rules are applied to all controllers and common knowledge that is available only in each active controller's domain is shared. In this manner, the global reputation of all devices is known, logged, and shared so that trust models are not just local and not visible to others. It has been found that this model in accordance with the invention scales well via shared reputation databases between active controllers.

In order to enable one Active Controller to communicate with another Active Controller and inherit the ability to stop client on client attacks across two separate active controller domains, common lookup and common forwarding/shunning rules previously discussed can be used. However, in order to ensure the integrity and protection against in-transit modifications which create a mis-attribution of an attack and impugn a clean source with a bad reputation due to in-transit traffic insertion or modification, Active Controller to Active Controller encryption of data with IPSEC to ensure non-forgery and non-insertion between them. Further, since transmitting the VLAN+MAC as part of the source IP address with IPV6 can be a bit untenable, an assigned IPV6 /32 as a global private trusted backbone between all customers or clients in accordance with a preferable embodiment is employed.

Although the above-described embodiment of the invention may sound a little strange to an expert, blogger, geek, weekend tinkerer or the like with some knowledge or experience in network security, this embodiment can be implemented to leverage a wrapper, thereby making the source address irrelevant for return communications purposes and instead to steal the source address (MAC, IPV4, or IPV6) for signaling purposes and passing notes between active controllers. Accordingly, this embodiment sets forth a dual tagging option.

As with the above-described inventions, embodiments, aspects, and features of the inventions, the present embodiment of the invention also ensures that every device on every switch or WiFi is put on a different VLAN. At that point, the source MAC address is redundant with the VLAN tag—as they have a precise one to one correspondence. Likewise, when two active controllers are communicating, the source address can be made redundant as well, since the recipient already knows who the sender is—and the sending active controller keeps a translation table of all communicants at layers, 2, 3, VLAN and trunking to remote active controllers.

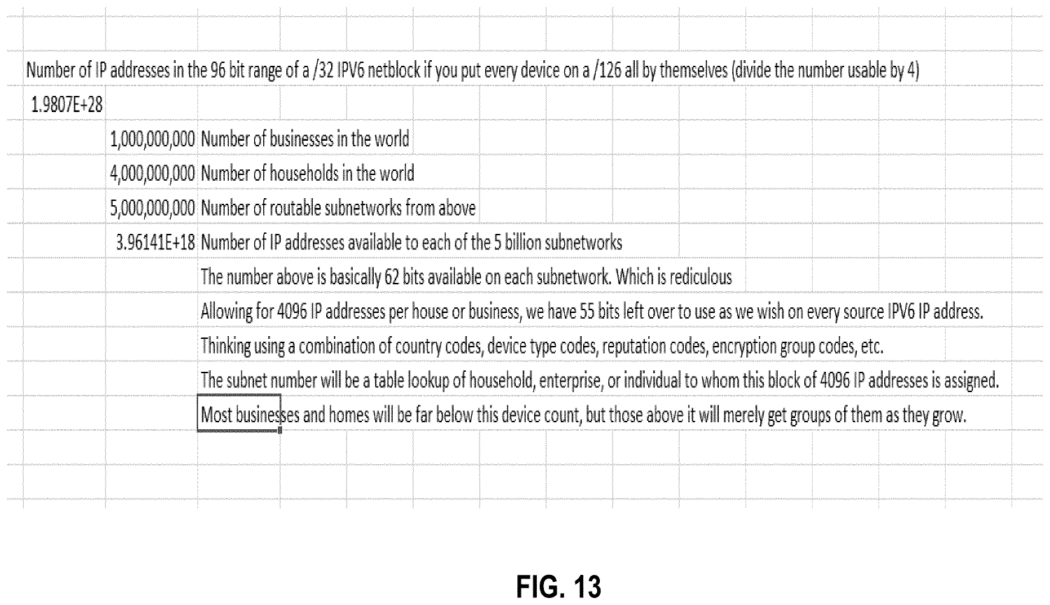

FIG. 13 shows a chart illustrating the numbers between a worldwide implementation of an IPV6/32 global private trusted backbone with rough estimates of the number of worldwide businesses and households, the number of available routable subnetworks, and the number of IP addresses in the 96-bit range of the/32 IPV5 netblock if each device is put on a/126 by itself. When compared to the VLANs 4096 IP addresses available for household or business, it would appear that the VLAN tags offer greater bandwidth and flexibility.

If desired, and in accordance with a further embodiment, the manufacturer code on MAC addresses may be encoded using Huffman algorithm and the whole MAC address may be used as 42 bits of the 62 bits left over. This may leave 62−42=20 bits for intrinsic fast tagging by using a 20-bit bitmask for a variety of pre-cooked enrichments of the source. Although this embodiment may be less efficient with time compared to a separate handshake containing all background on each node requesting remote access or communications with a remote device, it is a viable solution and therefore can be useful. Certainly, one could use these bits for server, user, history of hacking or nonlinear behavior (this would be 3 of the 20 bits). One could also have bits for simple concepts like “internal users only”, cheap IoT's that should only talk to outside and never to anything else inside (like a smoke detector, thermostat, etc.). Again, a table lookup of ever-expanding dossiers for each device and each device type/class is smarter and more extensible. Accordingly, the bitmask is a possible viable solution, albeit not he most time-efficient solution. it can be implemented as a shortcut until all of the secondary protocols and table mirroring or record requesting mechanisms are worked out. For example, implementation would include determining the level of detail an outside network should receive as compared to mirroring the whole table between Security Devices inside the enterprise globally. In any event, this embodiment of the invention is a novel new use of source addresses to convey real-time data inside the data stream which is in addition to very rich lookups done outside of the observed and controlled data flows.

As previously described, the devices and methods as described in U.S. Pat. Nos. 8,291,058 issued on Oct. 16, 2012 and entitled “High Speed Network Data Extractor” ('058 patent) and U.S. Pat. No. 8,472,449 issued on Jun. 25, 2013 and entitled “Packet File System” ('449 patent), are of particular importance in establishing high levels of reliability, accuracy, and integrity with respect to high speed data extraction, processing, analysis, and storage. Accordingly, the systems and methods disclosed in the '058 patent and '449 patent ensure that local packets have not been forged, inserted, spoofed, or modified, and that they came from exactly where they are attributed to. In this manner, trust and sharing of primitive data can be enabled globally. Thus, the locally vetted packets of data can be trusted and shared both inside a network and between organizations worldwide. To establish the ability to globally communicate and trust between implementations of the present invention, these communications are required to be trustable or the firm foundation leads to no trust at the remote locations when it crosses otherwise uncontrolled or unmonitorable communications.

The security device to security device communications will occur over a secure channel like IPSEC, where both devices are assured that the sender is the actual sender—and that nothing has been modified in transit, nor has anything been replayed or spoofed in transit. But any authentication method that is trustable will do. Encryption is also valuable for privacy and resistance to traffic analysis, plus other leaks.

Low-cost commodity hardware used as local switches in the nominal design has much security between the user port and the networked devices (desktops, servers, laptops, wireless devices, IoT devices, mobile devices, cameras, etc.) but unless mitigated, there is a security problem between the network (trunk) ports on each switch and the active controller. The presence of bit errors on local copper cables (and even fiber has losses, but they are less than 1 in a billion bits) makes all local communications subject to losses and packets which are modified by noise along the cable paths. IPSEC supports authentication which assures that all packets received by a switch or an active controller could only have originated at a trusted controller rather than an active or passive man-in-the-middle attack. Accordingly, the present invention preferably enables encryption with sequence, salt, and checksums, in order to ensure that the data received is indeed from a trusted controller, has not been modified, and thus can be trusted.

### Allowing More Trusted Flow to Bypass Network-Based Security Device to Decrease Latency and Load on Security Device and Routers

This can be a manual, automatic, dynamic, or periodic bypass. Based on the VLAN centric design option, this doesn't appear to be an option because every MAC address is on a separate VLAN design. Two or more active controllers are present on an enterprise and more than one IP subnetwork are present on one or more active filters—this design allows direct communications between devices to bypass the traditional router hierarchy across many previous network boundaries. Every port on a local switch can be on a different IP subnetwork from every other IP address on the switch—and Layer 2 broadcast domain groupings can be made on any port on any switch anywhere. Heavy users of remote devices (like servers) can just as easily be placed on separate IP subnetworks not based on proximity but instead based on frequent communications partners. This design creates broadcast domains on the active controller(s) without regard to where those ports are. Broadcast packets on Layer 2 or Layer 3 do not reach their neighbors on any switch unless the active controller allows it. Likewise, any two devices which are communicating regularly, are trusted, and those that perhaps are encrypted without any escrowed keys or corporate monitoring possible can be routed directly without adding to the load of intermediate devices by a number of VLAN and routing tricks which allow direct connections for single session pairs on specific protocols with any other set of constraints.

### Employing Accumulator System and Method to Enable Filtering and Modification of Traffic

In the '058 patent referenced above, an accumulator is described in the context of an audit, with the accumulator temporarily receiving and storing entity sets generated by a packet decomposer/parser engine until a stimulus triggers an accumulator flush its contents to long-term storage, where the stimulus can be the age of the data in the accumulator and/or the amount of free space remaining in the accumulator, to make room for receiving subsequent entity sets. When an identical entity set is received in the accumulator, the duplicate row is found and the statistical data element is updated, which includes an increase in the count of the duplicate rows seen by the accumulator. The present invention extends that capability from predominantly a passive device, into a more dynamic device that functions as a traffic filtering device to stop, modify, correlate, redirect, shape, enshroud, and so on, in a more active role than taught in the '058 patent so that the accumulator is enabled to effect change rather than simply watch and record.

A number of internet service providers use what is called a Domain Name System (DNS) sinkhole as a prior art solution designed to protect their customers from malicious attacks. This is accomplished by sending, via the DNS server, false results to a system looking for DNS information, to permit an attacker to redirect a system to a non-routable address for all domains in the sinkhole, or to redirect a system to a potentially malicious destination. To do this, a DNS server compares a DNS question to a blocklist of sites that are malicious, dangerous, have objectionable content, etc., and responds by not returning a valid IP address for the Fully Qualified Domain Name (FQDN). In most cases with Hypertext Transfer Protocol (HTTP), the response returns the IP address of a “this site has been blocked” web page. Although sinkholes have been used with some effectiveness in the past for shutting down botnets, blocking malicious sites and ad-serving sites, they can also be used maliciously by an adversary to block DNS services in what is called a Denial of Service (DoS) attack which is intended to make a machine or network resource(s) unavailable to its intended users. This is typically accomplished by overwhelming a targeted system, machine, device, resource, etc., with redundant, meaningless, excessive requests to overload or flood the system and either temporarily or indefinitely disrupting services of a host connected to the internet, akin to a crowd of protesters standing in front of a shop with the intent to shut the shop down by blocking real customers from entering or exiting.

In accordance with a further embodiment of the invention, smart filtering of DNS responses in real time is enabled. If there is more than one IP address in a DNS response, the IP addresses which a user policy has determined or determines to be undesirable and thus banned, are disabled or deleted, and only the safest options to the client are passed. There are many hosting sites with mirrors all over the world, and a DNS lookup will respond with multiple IP addresses for any given FQDN. For a variety of reasons, some of these IP addresses are safer than others in a single DNS response. For example, a host may have one server in a country with great privacy laws and a mirror in a country with considerable control over internet traffic through state-sponsored monitoring. As a further example, a host may have a mirror in a friendly country and a second mirror in an enemy country. With virtually all prior art solutions, the internet traffic is either completely blocked from the user or completely passed on to the user. Once the data has been fed to the client or server, the IP address chosen by the application is largely at random. Accordingly, the present invention enables smart filtering in real time of DNS responses, as discussed above. Instead of randomly selecting one address from a plurality of IP addresses, the present invention disables or deletes undesirable IP addresses, which can be preselected by a user, host, system administrator, etc., and the safest options are permitted to pass through.

The smart filtering of DNS responses, in accordance with the invention, can be enabled at more than one level. With HTML, for example, a single page may load an additional number of Source (SRC) links without the visibility or control of the user. With HREFs, the user may be required to click on an SRC link to open it—and users are continually trained not to click on mystery links in emails or random web pages to minimize opening malware. With Source links (SRC), the browser directly loads and executes these fetches and renders in the background without the user being able to see, control, or stop them. Worse, a single advertisement can be customized for each user—so that just because the previous billion people received a benign file, one targeted victim alone will get the malware infestation. The active controller of the invention is therefore enabled to monitor every direct IP fetch, every DNS lookup from a SRC link or an HREF click, then compares the IPs and FQDNs against a number of approve lists, blocklists, country lists of ownership, country lists of geolocation, BGP lists that map these IP addresses to carriers and the countries that own the carrier, to each single attempted, contemplated, or available connection. If there are safe choices, the active monitor will delete or hide the unsafe choices. If there are no safe choices, the active monitor will block all of them. Accordingly, the present invention provides a monitor and/or controller enables viewing, controlling and passing or blocking one or more SRC links, with storage of all activity including IP fetch, DNS lookups from SRC links, HREF clicks, and so on, for auditing the sources of all activities on the network, as previously described with respect to other hacking techniques such as spoofing, etc., using AI or machine learning for example, to thereby continuously update, in real time, the blocklists, approve lists, country ownership lists, country geolocation lists, and so on. This is especially advantageous, since knowledgeable attackers are constantly improving their skills, learning new hacking techniques, developing new or improved malware, ransomware, etc., in an effort to trick a system into gaining access as a trusted entity. Thus, the present invention is readily adaptable to new threats, with AI and machine learning for example, through the use of one or more active monitors/controllers/filters to continuously monitor internet traffic and updating its database of filters including blocklists, approve lists, ownership lists, geolocation lists, and so on, thereby thwarting or stopping new malicious attacks, threats, requests, queries, etc., as they come on line. According, the filters can be constantly, dynamically, and automatically updated to contain new knowledge of both safe and unsafe SRC links and HREF clicks. As described above, all data, events, and so on, are monitored, controlled, and stored to provide an audit trail of all events, requests, device communications, trusted and untrusted devices, sites, networks, etc., with monitoring and control being returned to the user, system administrator, or other authorized person, device, machine, etc., so that even a one-in-a-billion malware infestation is quickly blocked.

Another difficulty with prior art solutions is the limitation to how much data can be stored, since no device has unlimited memory. For example, the storage limit for approve lists and blocklists in firewalls hovers around 100,000 sites. This is highly inadequate, since there are over 100 million www.* FQDNs currently in use globally. Moreover, since there are approximately 4.3 billion IPV4 addresses and about 400 million IPV6 addresses in use, the minimum size table for filtering to be definitive about blocking or passing is highly inadequate to today's security challenges. Furthermore, since there are about 2.7 billion active FQDNs (hostnames and domain names) on the internet, the table sizes are entirely inadequate.

To overcome these seemingly insurmountable obstacles, and in accordance with a further embodiment of the invention, a system and method of loading the entire world's databases of IP addresses, FQDNs, routes, Autonomous System Numbers (ASNs), and reputation into each active filter is provided. In accordance with this invention, wire speed pass/block decisions on complex decision trees can be accomplished by enabling: 1) the black, white, ownership, geolocation, and reputation databases to be wholly loaded in the active filter and/or 2) a centralized and dynamically updated (always current) single copy of that information to be maintained without having to push out tens of gigabytes of reference materials to each monitor/controller or equivalent sensor regularly. In the latter case, the most popular lists are preferably pushed out, while the individual active filters send a query to a real-time look-up service when “unknown” information. When the “unknown” information is found in the look-up service, it then becomes “known” information and is preferably maintained in cache in the active filter to prevent endless lookups of the same sites or IP addresses over and over. The current size of tables required to maintain state and history and filtering preferences for security is about 4.7 billion IP addresses and about 2.7 billion FQDNs for a total of 7.4 billion entries in the filter tables. With history, there are about 14.7 billion entries in the filter tables. This is of particular relevance as malware attacks use a freshly registered or never-before used domain name or hostname (FQDN). One of the innovative features of this invention, therefore, is to ban all new domains and hosts from being accessed for the first 30 days, for example, after their first use globally. It will be understood that the length of time new domains and hosts are banned can vary significantly without departing from the spirit and scope of the invention. In some instances for example, where a new domain or host is linked with previous ownership known for hosting fraudulent websites, the ban may be much longer in length to determine whether the new domain is legitimate or fraudulent, and ultimately may be permanently banned and associated with a blocklist. Likewise, a new domain or host associated with known legitimate owners for example, can be set with a shorter ban, such as the first 15 days or 20 days after its first use globally.

Moreover, this preferable embodiment of the invention provides and enables architecture that supports a “new-to-me” criterion vs “new-to-all-of-us” criterion and captures every “first-seen” IP address and FQDN globally by each device. This particular aspect of the invention is partly based on the above-referenced '058 patent, which teaches a highly efficient system and method for extracting and storing network data without the otherwise impractically large storage space that would be required. With incorporation of the teachings and efficiencies in '058 patent, the present invention is especially capable of efficiently creating, maintaining, updating, and looking up extensive filter information including IP addresses, FQDNs, and/or other pertinent information in the context of real-time connections and traffic at line rates. This innovative approach takes security to a new level, which enables the active monitor/controller(s) to both learn and block, for a predetermined period of time, new filter data, that preferably includes new IP addresses and FQDNs, and can further include, but is not limited to, reputation lists, blocklists, approve lists, ownership lists, geolocation lists, etc., on tables that are massive in size which, in accordance with the invention, can comprise many billions of filter data as described above. With the amount of random-access-memory (RAM) available in commercial hardware, for example, table sizes can comprise up to 15 times more space than what is required to track every host and IP on the entire internet worldwide, even if they are all seen in conversations flowing only through a single active monitor/controller of the invention.

Moreover, by employing the massive table size capabilities in association with our '058 patent, this embodiment of the invention is significantly enhanced to provide and enable real-time filtering, including blocking, based on real-time lookup of lists exceeding 5 billion entries. Accordingly, the present invention is capable of creating, dynamically updating, and accessing active filter lists of the above-described data for example, that are much greater in size than conventional blocklists or approve lists typically limited to only a few hundred thousand entries in size.

The present invention also enables loading of the entire list of all IPV4 and IPV6 IP addresses that are currently in use as active filters and, preferably through the use artificial intelligence and/or machine learning algorithms, make intelligent decisions to block or pass address information and associated communications data based on their blocklist or approve list affiliation, which may change from moment to moment depending on whether the address on a approve list for example, displays bad-actor behavior and immediately blocklisted, as described above. Intelligent decisions can therefore be made in real time, preferably on the entire approximately 4.3 billion IPV4 address spaces as well as all of the IPV6 spaces currently in use, as well as future address spaces and their increased number of address information.

In addition to the newly registered domain names discussed above, billions of registered IP addresses have never been used at all, and hundreds of millions of IP addresses have never had a hostname mapped to them by DNS. Many of these IP addresses without a hostname have been used for hacking, exfiltration of secrets, covert command and control, and other malevolent and/or nefarious purposes. The information regarding unused registered IP addresses and IP addresses without hostname mapping are also associated with the table as active filtration data. In this manner, the active monitor/controller/filter device, whether embodied as a single unit or separate units that work together, can look at every connection, learn it, look it up, and track it over time to determine or discover malicious signs, lack of history, and commonality with other threats. For example, each day trillions of DNS lookups occur worldwide across DNS service providers, and DNS spoofing happens all the time to steer victims to specialized compromised servers globally. Not only does the present invention try to correlate bad IP addresses and bad hosts, but enables blocking based on the DNS answers received by every device, which may be different than what has been seen globally by anyone else. It is common for a victim to have a unique compromise that was never before globally seen. Thus, the only way to ever obtain the unique DNS answer for every potentially unique compromise is to look at everything then compare it with everything ever observed before globally. With known DNS, TCP, UDP, HTTP, FTP, NTP, TLS, SSH, SNMP, STUN, SIP, and many other types of sessions, one practical way to locate anomalies is to learn what is normal and note when a single packet or session is different from established norms and patterns.

In accordance with a further embodiment of the invention, a blocking filter is provided that can maintain state and filter entries which link DNS lookups from specific machines to the IP address returned for that machine. With shared hosting, it is altogether common for two different websites to be hosted on the same IP address by different customers in the same hosting center—and one can be innocent like “onlyinnocentwebsite.com” (an exemplary fictional approve listed safe site) mapping to the same IP address as “pleasehackndestroyme.com” (an exemplary fictional blocklisted malicious site). Thus, it would be appropriate to block one and pass the other, but not possible without the present invention, including different embodiments, features, aspects, systems, methods, solutions, algorithms, and so on, described herein. This is because the prior art is incapable of discovering or knowing which client requested which hostname, and therefore cannot know which IP pair to block and which IP pair to pass.

Thus, the Active Monitor of the invention is uniquely able to correlate traditionally uncorrelatable activities which adversaries use to hide covcom, command and control, probing, signaling, status, readiness, data exfiltration, loading of customer malware, as well as signaling success and failure of any of their operations.

By way of example, the active monitor through the above-described correlation of traditionally uncorrelatable activities can discover a rogue packet out of sequence, one with a checksum error, a duplicate packet that is different than its duplicates, a DNS lookup sent outside the authoritative chain, one sent to a non-DNS server, or even a machine that makes a DNS request it never uses for a connection. To enable this feature of the invention and for other reasons which will become apparent, the present invention also stores all SRCs and HREFs, fetches that are hidden in scripts as seeds that appear legitimate but include an SRC link for which a DNS lookup happened with a suppressed fetch, which can be a covert command and reply.

The active filter of the invention maintains state at a level previously deemed impossible and unnecessary because security breach detection and countermeasures of the prior art are predisposed to lose in a battle of wits, the prior impracticality of storing large amounts of data, as well as the sophistication of today's adversaries and the advanced, technological tools, tricks, and tactics available to them. A FIN ACK scan is a very common survey tool used by adversaries today which is impossible for a firewall to detect without maintaining state awareness of TCP. ACK scanning for example is an unusual scan type as it does not determine whether a port is opened or closed but rather whether it is filtered or unfiltered. This is used by hackers when trying to probe for a firewall and associated rule sets. FIN scanning is especially problematic as a firewall is typically looking for SYN packets and blocking them. FIN packets, however, are able to transparently pass through the firewall without modification since open ports ignore the FIN packet, while closed ports reply to a FIN packet with the RST packet. Accordingly, due to the nature of TCP, the combined FIN ACK scan can be disastrous.

Adversaries know how firewalls work and how networks are architected, giving them ways to hide effectively in a sea of normal traffic. For example, DNS lookups are seen and perhaps logged by the corporate DNS resolver, but the corporate firewall does not consume the logs. Likewise, the VPN server brings in remote users to the corporation but generally IP proxies these remote users to internal IP addresses so internal servers do not know what user has come in from where in the world.

Further in accordance with the invention, the active filter preferably detects changes based on behavior, such as reputation inversion, e.g. when a device flips from supplying content to stealing content. The internet is built upon billions of devices. Not all devices from inside conflicting countries are malicious, neither are all devices from inside diligent organizations safe, as such devices can change in a fraction of a second from benign to malicious. However, by maintaining a connection state that is on at all times with all connections in accordance with the invention, the active filter detects when a device flips from being a supplier of content to a drop box for stolen content. Likewise, the active filter of the invention notices when a keep-alive beacon such as those used for STUN (a protocol to allow a VOIP phone to ring when behind a firewall) flips from being benign to being used for covert communications or remote covert control of a protected device inside a network. AI is preferably used to compare the activities of all devices on all conversations to all others of the same type, version, build, and function with each other. When one behaves differently, it stands out when viewed, not from a signature or malware historical framework, but only when real-time data is created for use with AI. Accordingly, the Exfiltration of data in real-time can be seen and stopped, as well as the detection of remote control and covert communications riding on otherwise routine communications.

In accordance with a further embodiment of the invention, all of the action items that build on top of the accumulators, such as set forth in the '058 patent discussed above. Preferably, the AI and behavioral analysis rides on top of the analysis of every field in every packet of every protocol, and also looks at changes in all flows over time to dynamically adjust the system of the invention so that it is constantly automatically updating and improving as more data is received, analyzed, and the system adjusted based on the analysis.

### Accumulator System & Method Includes Blocking or Passing in Real Time Based on Real-Time Behavior Instead of Recognizing and Logging for Further Analysis

Further in accordance with the invention, the ability to block, pass, and modify traffic based on real-time knowledge of state, conversations, context, expected and historical behavior, and new behavior is provided, and builds on the accumulator and related teachings of the '058 patent described above. This invention also preferably provides the ability to recognize real-time flow changes and other patterns of behavior which show attempted hacking, scanning, password guessing, a known login being used from other than its normal place, and many other more sophisticated patterns, that the prior art cannot monitor or respond to. This is due to the real-time monitoring and the efficient and quick storage of large amounts of data as described in the '058 patent and '449 patent for example, which now makes possible what was previously not possible in the prior art, by turning full bloating logs into moderately and non-bloating accumulators. This aspect of the invention, to create real-time, in-sensor accumulator records moves graph analytics into the sensor which otherwise could only be accomplished by moving horrible quantities of bloating logs to key value stores in massive data repositories, which make untenable real-time decision making. Accordingly, the combination of accumulator and related teachings of the '058 patent and graph analytics and AI applications of the invention enables the analysis of billions of connections in real-time. More importantly, it also enables these billions of daily connections (and stray packets) to be put into the historical context of trillions of communications relationships in historical data and in the context of real-time contemporary conversations on other networks.

The '058 patent describes how accumulators are used to enable rapid decoding of traffic in real-time, allowing the rapid collation of like traffic into discrete summaries by selector and protocol. This invention extends that model and radically shortens the time required for processing, enrichment, and modeling behavior to meet the goal of real-time blocking of traffic. The '058 patent was implemented in a two-tier scheme in which real-time decoders wrote into RAM in a way that repeated traffic on the same conversations resulted in real-time row updates rather than the creation of new rows in an output log. In this manner, the device supports drastically higher update rates and new row creation rates than is possible without this improved accumulator and data extractor. The present invention as described herein, extends that system and method in real-time consumption of real-time generated data, rather than waiting for a distillation process to write results to disk from RAM.

The accumulator as described in the '058 patent is modified to function as a behavior and statistical memory and behavior remembering tree, so that learned norms of behavior can be updated and kept current in real-time—such that detected departures would not be from the ideal behavior, but from actual measured behavior. In one prior art neural engine, data are processed from input to output with no retention or memory of what has been observed. Thus, this prior art neural engine doesn't learn, but simply processes input to output in a clock cycle linear pipeline. The approach based on the '058 patent provides memory of behavioral norms so that departures from observed local behavior are detectable separate from or integrated with the neural engine.

In accordance with a further embodiment of the invention, a neural engine, AI, or other machine learning can be used to layer a next layer on top of the above-described accumulator of the '058 patent to dynamically update the filter information used for determining the normal role and trustworthiness of data and devices as described above.

Method and systems as provided herein may improve security audit by providing an independent audit. In some cases, a network monitoring device such as a miniature personal network appliance may be inserted between each individual device and the network. In some cases, the network monitoring device may be a two-port device that is plugged between the monitored device and the network such that all traffic to and from the machine is monitored. Inserting the inline network monitoring device before the first network switch can beneficially prevent any network traffic from bypassing the audit. Method of Looking at Exfil vs Download, Inbound vs Outbound, Both Gross and Fine

Asymmetry of rules is a critical security requirement: it is allowed for a client to SSL connect to the cloud, but it is not acceptable for the cloud to SSL connect to a client. Likewise, users are allowed to connect to servers, but servers are blocked from making connections to sketchy servers, hosting centers, or countries.

Machine learning has been trained to learn reversals. For example, the Session Traversal Utilities for NAT (STUN) is a network protocol used by VOIP phones. STUN works by ensuring that the VOIP phone can always receive phone calls from an external switch or caller by keeping an outbound connection always alive and active. A huge number of benign and most malicious COVCOM protocols work on this principle, that firewalls and Network Address Translation (NAT) boxes effectively stop outside-in connections—but all insider-out connections are allowed. Programs like network meeting software and remote computer access solutions allow outside devices to reach the inside of a protected network by using call-homes to keep connections up so they can be used to accomplish outside-in remote control of devices without being blocked by firewalls. The active controller tracks all inside-out connections which are either constant or periodic—to allow them to be seen, characterized, and blocked.

The active controller in accordance with the present invention preferably employs the accumulator and related teachings in the '058 patent to build flow tables for every single connection on all protocols, preferably through decoding all of the fields. Alternatively or additionally, the present invention also uses a catch-all recorder with full packet capture (PCAP) recording every bit of every packet. Accordingly, every packet is accounted for in every protocol all the time to and from every device. This preferably includes DNS, non-IP, TCP, UDP, Ethernet, 802.3, along with any protocol or bitstream and smuggling data or control buried in packets with bad checksums.

As described above, flow changes or reversals can happen on any port with any service. HTTP can be used to read pages all day, but can also push, upload, or post files to a web server. Looking at rules, it may be defined as acceptable to download videos to watch all day, but it may not be acceptable when the client device uploads 8-12 MB files a few times a day which is not consistent with the behavior history associated with the client device . Likewise, protocols like FTP can download or upload files, and networks do not measure or block when the flows are reversed from one of the devices flipping from consumer to uploader. This is especially true on encrypted channels: it generally does not know what was being uploaded.

Reversals can be at the gross or fine level. At the gross level, data can be downloaded from the Internet or uploaded to the Internet. The reason behind so many large security breaches remaining undiscovered for years is that neither fine nor gross outflows from a network are suitable for real-time or long-term analysis.

These improvements in detecting and stopping the outflow of data are more efficient if they are used with the '058 accumulators. With an accumulator, traffic with billions, trillions or more of packets and connections are more compact and thus can be kept for years, which allows long term analysis of behavior and retention of all flows, both gross and fine. At a finer level, data can be hidden in a variety of ways, as described below.

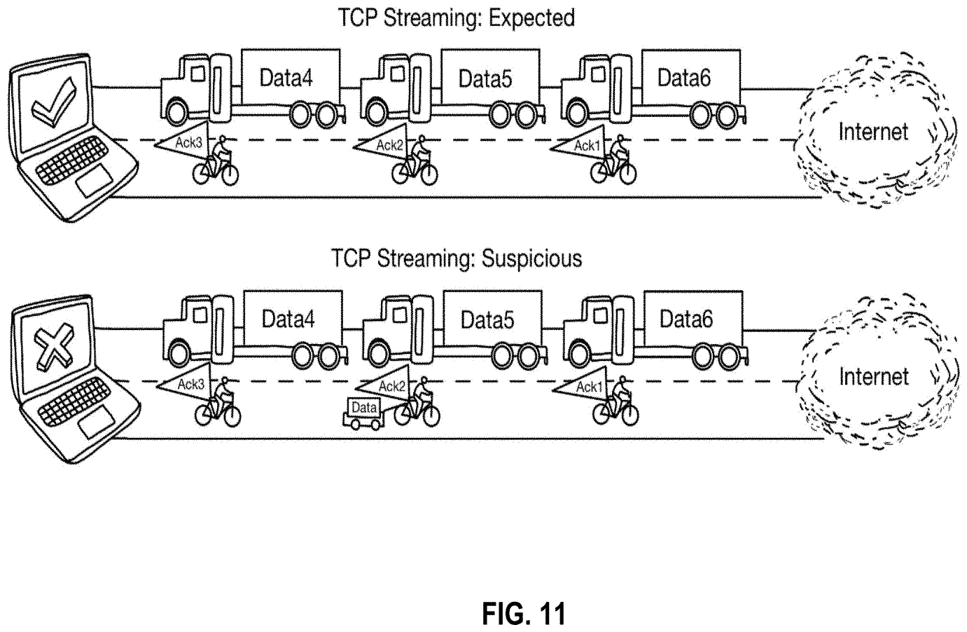

Referring now to FIG. 11, a single TCP data stream is illustrated, for both expected and suspicious streaming, in accordance with an example of how data outflow is hidden by adversaries. In TCP, each packet is acknowledged (Ack) by the remote device by sequence number. In reality, these sequence numbers are not the exemplary 1, 2, 3, 4 but instead are an increment which equals the number of bytes of payload that have been sent since the last Ack. An incorrect assumption by those unfamiliar with network protocol is: when watching a video, there may be thousands or millions of packets coming downstream from a video server, and a few packets may flow the upstream way. In reality, this ratio of inflow bytes to outflow bytes is closer to 60/40 or even 70/30, and almost 1:1 on packet counts each way for TCP. That is because every packet with video is acknowledged by a packet (e.g., Ack) along the upstream way. Data thieves can stuff a few bits of data into the Ack packets without changing the packet length, because most Acks don't fill a 64 Byte minimum packet length.

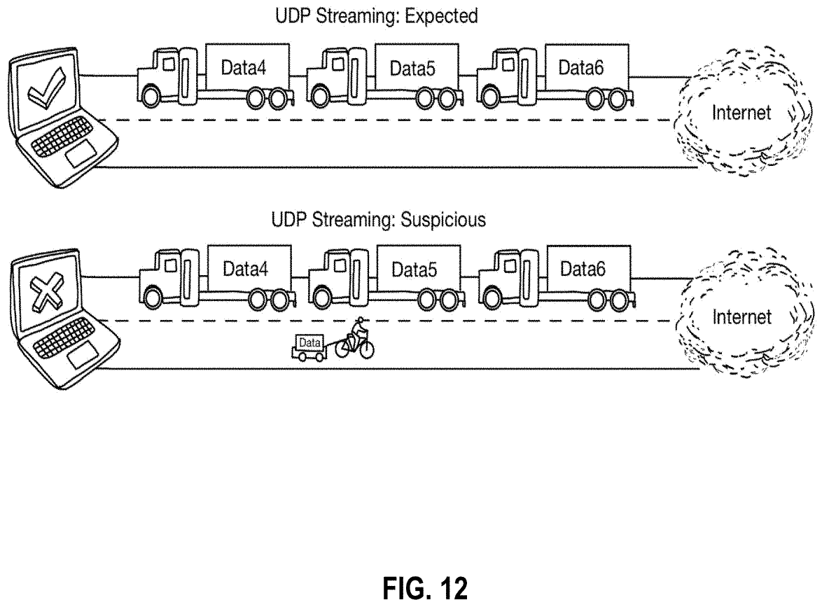

With reference now to FIG. 12, a single UDP stream is illustrated, for both expected and suspicious streaming, in accordance with an aspect of the present invention. UDP is connectionless and, unlike TCP, does not contain per packet Acks. However, data flow in both directions (in and out) is common as requests flow and answers return. An adversary has a variety of ways to insert EXFIL or other covert communications along UDP in ways to disguise the back channel, so a conventional solution may not detect it. The active filter in accordance with the present invention, decodes and analyzes flow by protocol, using a variety of fixed and learned rules to flag EXFIL and covcom hiding in the flows, as schematically shown FIG. 12.

In accordance with yet a further embodiment of the invention, a method is provided for discovering remote access and keyboard control of a device. Any protocol can be used as a Trojan backdoor for a hacker to compromise one of the devices as a human-driven survey and penetration tool. Much has been written on how ransomware campaigns are initiated by remote control operators who scan, survey, discover, breach, and assess the network's treasures and resources before launching a ransomware campaign. The present invention measures the amount of data flowing in (even on a reversal of connection) to look for and block remote console operators from outside. As described above, this is preferably accomplished through the provision of one or more active monitors/controllers/filters either alone or in combination, which can be embodied as hardware, software, and/or combinations thereof with tables as described above including one or more lists, such as approve lists, blocklists, and the like, to monitor every device, port, data packet, behavior, data flow direction and rate, etc., to determine whether breaches are occurring or have occurred, and stop the theft of data, unauthorized data encryption, etc., whether the flow of data is into the network from outside, out of the network from inside, and laterally within the network between devices. When large amounts of data are being uploaded, especially when it is inconsistent with normal behavior of the user or device. For example, when it is outside of normal business hours, the abnormal behavior as described above may be detected and stopped by the active controller before damage can be done.

With the above-described inventions, embodiments, features, aspects, and variations, the behavior of client devices and the associated users is largely unpredictable. This is because a user may make a human error, whether in ignorance, in forgetfulness, or deliberately, which may result in potentially compromising the device and potentially the entire system with all other devices. Accordingly, the present invention enables much more rapid learning of ranges of normal behavior, enabling security control for human error, servers, IoT devices, as well as other devices and machines connected to the network. Servers, cameras, TVs, Video Conference devices, VOIP phones, thermostats, lighting controllers and many other devices abound in networks and are often not separated from organizational traffic. The active controller may include machine learning algorithm that learn and enforce behavioral rules appropriate to each device or user. By way of example, smart thermostats generally communicate with HVAC systems on dedicated wires and communicate with the internet via WiFi. It is generally not a normal behavior for a smart thermostat to access other data such as a user's contact list and/or send the contact list through internet, either via wires or WiFi.

IoT devices, such as the thermostat, cameras, lighting controllers, and so on, are becoming more common in homes and businesses, with their security status having no basis for trust. Thus, the active controller of the present invention ensures that the thermostat is not allowed to communicate data resources it should not have access to. The thermostat instead is walled off and not allowed to hear ARP responses or any other network traffic of any other device on the local network. Instead, the thermostat can only talk to the cloud in byte counts and with cloud servers customary and necessary to their limited role. Specifically, most IoT devices should not be treated as guests, but untrusted aliens who are not allowed to gather data from the network and EXFIL the data anywhere. Thus, in accordance with the invention, IoT devices is limited with natural functions such as DHCP to get a valid IP address, do DNS lookups of support networks, and report telemetry and receive commands. If however, a IoT device, because of its special nature or function, should be treated as a client device, that capacity can be limited either by manually specifying or automatically detecting the particular function(s) or purpose of the device, along with the necessary communications channels, data flow direction, type of data, and other information to ensure the particular specialized IoT is not the weak link in the system. As IoT technology develops and new uses or roles for such devices are discovered, the present invention also dynamically changes, as described above, using machine learning and/or AI algorithms to create and/or update lists associated with such devices, and included along with the filter data, as previously described.

Other noteworthy security profiling and security control functions extend to Televisions and other devices capable of capturing voice and video. Most of these devices have voice recognition enabled by cloud services such that they record and stream data, from inside presumably secure areas, and then outbound without warning or notice. Accordingly, the active controller of the invention preferably keeps record of all times that these devices are silent recorders and provides that information to security staff or other authorized personnel, who can block such activities permanently at any time without counting on the discretion of the devices to disable such recording and exfiltration features. Alternatively and additionally, machine learning algorithms may also analyze and disable the recording and/or uploading activities.

Many IoT devices only feed cloud-based enrichment, management, and reporting systems. Thus, in accordance with a further embodiment of the invention, the active controller preferably isolates these devices from all network resources so they cannot be used to compromise additional corporate resources, home network resources, or other private network resources.

Some IoT devices serve as data feeds for internal telemetry or process control systems while others are serviced by a single vendor vertical model—such as HVAC systems, power plant controls, refinery controls, etc. The active controller of the invention preferably isolates these systems from the rest of the enterprise.

Moreover, the active controller also preferably isolates the vendor's remote access channel from the rest of the internal network. In some cases, VPN may be used as the identifier for a distributed enclave. Systems and methods herein beneficially allows the monitoring and security control capabilities extend to a virtual enclave at a larger campus or global network scale. The unique identifier (e.g., VLAN tag) within a virtual or distributed enclave (e.g., established through VPN) can be used for the various security, monitoring solutions as described elsewhere herein. For example, in a well-known breach of a large retail establishment in the not-too-distant past, the HVAC systems installed included remote VPN access, which was intended only to allow the HVAC vendor remote access the installed HVAC system at each store to obtain telemetry data. Unfortunately, there was no isolation of the HVAC VPN access from the rest of the internal network. This allowed an adversary to use the vendor's HVAC VPN access to attack and compromise the Point of Sale Terminals in a huge number of stores, then use this trusted access to EXFIL the credit card information as part of the “trusted” connection pool. Thus, in accordance with the invention, the active filter preferably leverages the learned behavior of all systems and block suspicious activities. For example, as described above, direct mapping for a global network may use specialized source MAC addresses or source IPV6 addresses encapsulated in a protocol wrapper, VPN tunnel, or other encapsulation method for larger or global networks. Since the method herein already performs lookups in tables of size in the billions, direct mapping and transfer of credentials and measures of trust can use in-flow credentials put in at the source network's active controllers or shared by network lookup services.

Servers typically only respond when spoken to. Servers can be internal-only or public facing or both when serving clients. All servers, however, have interactions in which they are clients for necessary functions such as NTP, DNS, DHCP, and some data calls to other servers, such as for software updates, patches, enterprise management, and so on. The present invention advantageously unifies all communications into predictable and learned behavior for each software build and hardware vendor when the server is acting as a client. With this predictable and learned behavior, the present invention preferably allows for departures from the established behavior baseline that may be caused by the installation of additional software, by either allowing or blocking that installation. This capability is powerful because each endpoint of a communications link which a server attempts to open can be evaluated on the active controller of the invention as being on approve lists, blocklists, degree of trust/distrust, real-time behavior, and other filter criteria as described above.

### Method of Extending Novel Trust, Monitoring, and Control Models

In accordance with the “Zero Trust” principles, the above-described inventions, embodiments, features, objects, aspects, variations, additions, accumulator integrations, monitors, controllers, filters, as embodied in hardware and/or software, and so on, advantageously move audit and control outside the computers and other devices being protected so that all communications inside an enterprise to be monitored, can be blocked, controlled, modified, inspected, and isolated. This removes the uncertainty of conventional solutions with respect to the ownership and location of every packet transmitted, and thus removes the ability of an adversary to spoof or falsify traffic in the local area network, beyond Layer 2 enclaves to enterprise, global affiliates, trusted collaborative backbones, and the entire world. Thus, the above-described inventions, embodiments, and so on, essentially eliminate the need for an enclave—simply because all trust is removed, as well as the possibility of an adversary getting inside the enclave.

The above-described inventions, embodiments, and features work together in establishing trust, history, habits, behavior, and security within an enclave or enterprise. Accordingly, every packet sent by each device, every flow, is recorded and analyzed. When some devices are compromised, the local network's active monitor allows them to communicate with the outside world, but not with any other enterprise servers or users. In this manner, the servers, users, networks, and devices associated therewith are isolated from the compromised device, while still allowing it to function. For example, if the network includes devices such as a security camera, smoke detector, thermostat, HVAC controller, and so on, where the only function is to measure something and report it to the cloud, but the active monitor of the invention caught that device trying to scan the network for open ports, repeatedly trying random usernames and passwords in an attempt to penetrate enterprise devices, the active controller can then isolate the device so it can still do its basic job but can no longer affect the network.

Thus, the present invention can force devices with bad behavior to have only the very limited access thereby forcing the device into good behavior. In addition, the present invention is capable of updating the active controller to include a list of functional bad actors that require special handling and thus can selectively communicate the status of such devices as untrusted but functional under very limited conditions. The communication of such devices to other networks, including the level of trust and history of behavior, known bad actors could be appropriately banned, shunned, filtered, isolated, mitigated, or dealt with in numerous other ways.

Thus, in accordance with the invention, active controllers actively manage the devices in an enclave or enterprise. The benefit is that compromised devices are isolated and lateral spread is prevented, data exfiltration is prevented, COVCOM is discovered and blocked, and so on.

When any two devices from anywhere around the world communicate and both of them are under the monitoring and protection of an active controller, there is a relatively large buy-down in the zero-trust model. If the above-described tagging is used as a unified global “every packet is traceable back to the original source” standard, the foundation for a higher level of trust can be established. This is because of several reasons:

There is a consistent global numbering scheme for all devices;

There is a cryptographic overlay to ensure that the credentials are not forged or modified between the remote protected networks;

Behavioral analytics and risk classification ratings are not set by an individual company, manager, organization, or device—they are consistent and unchanging globally. Where prohibited by law or policy, the networks simply cannot join the extended network;

The tagging methods described above set forth one of many ways, in accordance with the invention, to accomplish the creation of a secure calling card, which guarantees knowledge of the remote devices to each other and further removes the possibility of not being accountable, traceable, and removability from the network;

Unlike IP networks, IPsec, SSH VPNs alone, this tagging method makes the whole participating world able to understand the nature of the remote communicant. In particular, it addresses the basis for Zero Trust—that is, if a machine is trusted explicitly and has been trusted for a long time, even though a user can perhaps walk over to it and touch it, there is no way of knowing whether it was compromised 5 milliseconds ago.

The tagging method and mutual assurance of communicants is architected as two levels of information for the remote network. The initial and all subsequent packets show the actual IP address, the MAC address, the device type, and some basic trust items. Once received, the active controller at the receiving location and the active controller at the sending location have the ability to quickly share additional vital information for risk analysis and decision to accept or reject the communications. This tagging method overcomes several of the foundational problems with global security as well as local security within every enterprise.

In conventional networking, MAC addresses do not propagate through any router port—so there is just no way for a remote device to have any confidence that a particular IP address is the device it used to be. It can be a new piece of hardware with the same IP, it can be that a DHCP lease expired and a different IP address was issued.

In conventional networking, IP addresses can be spoofed, so any device can pretend to be another within certain routing scope limits. The rules are different for TCP and UDP for example, where UDP packets can be spoofed from anywhere in the world with little resistance.

Each active controller of the invention logs the MAC address of every communicant on every packet, uses the VLAN tag from each port (which is unique on each network), and logs the IP address for each packet mapped to the MAC, Port, VLAN, device, and time. MAC addresses map back to a device on a port (when using the VLAN per port tagging method of the invention described above). Accordingly, it is known that the communicant is a specific device and whether it is the same one as before. This logging overcomes a critical flaw in all conventional network security logging used today (e.g., packet captures, NETFLOW, RMON traffic analysis, system logs, remote login records, etc.) where such conventional devices do not keep their IP addresses forever, and conventional logs cannot know when an IP moves from an old device to the next device being assigned IP by a DHCP server.

Using MAC, a physical port on which a switch, VLAN associated with just that physical port, and associated traffic data in accordance with the invention, it provides information regarding who is where, which communications are authentic, and which are attempted forgeries (which most likely are blocked by the present invention). Further, when a given network device changes IP address over a period of years, the collating base no longer is disjointed over time. The new tagging system and method of the invention injects a stable consistent way to track every device over time along with all of its upgrades, movements, IP addresses, and communications.

The present invention also preferably logs when hardware is upgraded in an office, knows when a laptop moves from wired to wireless, moves from Ethernet in an office to wired in the conference room for example, and integrates that history seamlessly to compile reputation and history. This is a fundamental correlation problem which can be solved with truly static IP addresses for each device for life, which is not realistically achievable with conventional devices due to the realities of IP networks needing to be routed. The tagging aspect of the present invention solved this problem, as described below.

Just like building reputation for people, the present invention builds reputations for devices. The present invention saw and recorded all attempts at covert communications, noted all of the files they sent out hidden in traffic, knew every virus they ever had, every time they attacked anyone, every time they took a file that wasn't theirs, every time they attempted to log in as someone else, and every time their machine acted weird. Accordingly, the present invention is capable of learning everything about every network device through many interactions over the years.

With uniform standards of tagging in accordance with the invention, auditable accounting, open sharing of role and risk and trust for all devices, the present invention thus sets forth systems, methods, and active devices that are programmed to trust nothing and verify everything in network communications—and thus their underlying devices. If a compromised device can't communicate, the compromise can't accept remote commands and can't send out confidential data stored on one or more devices connected to the network.

### Detecting Call-homes, Covert Signaling, Remote Control, and EXFIL

The present invention has been described as detecting client and server connections for UDP (user datagram protocol) and TCP (transmission control protocol). It will now be described in the context of how protection against call-home devices, remote control, and so on, can be accomplished with the present invention. In order to do so, the client is not inside the protected network as provided by the present invention, as may be the case with a conventional server or a desktop/laptop/client, and instead put the client in the business of finding compromised devices that are calling home for a remote master to issue commands to them.

It is important to understand what a “call-home” means in the context of this invention. Accordingly, local networks, homes, and businesses—basically all networks, are set up to allow local users to connect to anything they want on the internet, but usually nothing on the Internet is allowed to initiate a connection to the Local network (except DMZ hosts, which are not relevant here). Even the cheapest NAT (network address translation) boxes effectively block outside-in connections while allowing most or all outbound connections. The difficulty comes when something outside a network needs to alert, update, or control something inside the network. For example, when a person is at work and wants to turn on their air conditioner remotely at home, the only way to make that work is for the smart thermostat to initiate a connection from inside the person's home to a server on the internet (a call-home). The thermostat keeps re-initiating this connection so that it is always “up” so that messages can be sent through the home's NAT or firewall in the outside-in direction which is always blocked. So, in this context, a “call-home” is any communication from a device inside a network to the outside world designed to allow reverse direction command and control. Thus, call-home function should be closely monitored.

### Call-Home Detection

There are detectable differences between call-homes and normal traffic. Call-homes designed by criminals intend to blend in with normal traffic and not be detected. Therefore, some detecting rules are universal and effective all the time, while some are less reliable from both accuracy and completeness standpoint.

Some call-homes are benign and routine. For example, software and firmware update checks YUM (Yellowdog Updater, Modified), APT-GET (advanced package tool), GIT (a free open source software version control and patching system), PIP (acronym for Pip Installs Packages), Yarn, Windows Update, and so on; NTPs (network time protocols). Some call-homes are necessary for functionality, but are abused. For example, the forerunner of STUN (Session Traversal Utilities for NAT) was created by a music download service, which maintains a steady and ever-live outbound connection to a meet-in-the-cloud relay. NAT (Network Address Translation) traversal and file sharing utilities are a generic capability implemented in a number of ways. They send a keep alive outbound packet (usually TCP or UDP but can be any protocol) periodically (e.g., as often as every 19 seconds) to maintain an outbound connection—so that an outsider can ride this connection in the reverse direction. This is a NAT or firewall bypass method that malware and spyware use to allow remote control from the outside. However, this example is only to recall the history. In the present context—a call-home is used in the generic sense for any persistent connection initiated inside a network or enclave to the outside;

With respect to SIP/VOIP (Session Initiation Protocol/Voice Over Internet Protocol) phones, if the person with such a device has a conventional firewall or NAT, it is not possible for an outside device to initiate an inbound ring, because inbound connections are all blocked.

With remote access PC products that allow a user to connect to a home PC from a laptop, remote desktop RDP, and other remote control solutions use a variant of this conventional method, which can be used as a backdoor by adversaries seeking to gain access to the network. These remote access backdoors to enter the conventional internal network from outside should only be provisioned and made available to employees by the network operator, not left up for individual employees to purchase and deploy for personal remote access to corporate resources, because the organization will have no way of monitoring what confidential data is flowing out or what remote commands are incoming. This is because most of the products for remote connection encrypt all of the data flows with keys not shared with the enterprise. Thus, the purpose of this embodiment of the invention is to find all call-homes, whether they came from malware, spear phishing, back doors in software, were installed by a person, or came with the hardware when the device, PC, or other machine was purchased. The present invention recognizes call-homes from traffic, and leverages known services from established suppliers so that communications are categorized by supplier. In this way, enterprise-sponsored and approved remote access is allowed but all others are blocked.

In accordance with a further embodiment of the invention, the following methods for detection of call-homes are described: a connection or UDP request that is made when no user is present on the machine is by definition automated. Thus, a call-home can be identified as any outbound connection from a device that happens both when a user is present and when no user is present. For instance, if people work in an office or remotely work, they eat, sleep, go to meetings, take breaks and only work certain days a week and a fixed number of average hours. Call-homes is detected when humans aren't present.

In some cases, call-homes are also indicated when the communication is useless or not used, such as a DNS (domain name service) lookup for which no connection is ever made. DNS lookups for DGA hostnames can be covert EXFIL (exfiltration) or signaling. If a communication seems to have no purpose or payload—such as with all keep-alive call-homes, this is a detection method in accordance with the invention.

In accordance with a further embodiment of the invention, covert signaling is used to detect a call-home. DNS and HTTP (hypertext transport protocol) are universally allowed outbound from every network, so these is a natural channel for covert signaling. The invention covers all protocols, including IRC (internet relay chat), FTP (file transfer protocol), SMTP (simple mail transport protocol), and SSH (secure shell) as prime COVCOM (covert communications) channels chosen by adversaries. There is a big difference between encrypted traffic that can't be monitored and covert signaling disguised as normal traffic.

In accordance with yet a further embodiment of the invention, remote control detection is used to detect a call-home. This detection method is novel and widely universal in its adaptation, and include the rules associated with the security device of the invention, such as the active monitor, controller, filter, and their equivalents. These rules facilitate the automatic detection of remote control than conventional methods. The normal case on almost every protocol is that the client asks a question or sends a command to the server—and the server replies quickly.

In remote control cases, the client initiates connection to an external server—but the connection is kept alive by the inside device making repeated connection refreshes or re-initiations over time to the outside. In both criminal remote control cases and benign call-homes, such as the keep-alive for ring for SIP phones alike—the outbound connection is only there to ensure that inbound requests won't get blocked by the firewall or NAT. There is no limit to what outbound connections are usable for hostile network remote control or data exfiltration—all it takes is for the outbound connection to be allowed by the firewall.

Accordingly, in accordance with the remote control detection method of the invention, the response timing is used to determine who is in control, by looking at each layer of communications nesting from outer to inner protocol layers. Call-homes can be randomized but are typically at fixed intervals. If the underlying protocol is TCP, each call-home packet is answered by a TCP-ACK (a TCP acknowledgement packet), so there are multiple intervals at play. The call-home will be immediately answered in TCP by the ACK, but this ACK is trivial if it contains no extraneous payload. If the call-home is connectionless like UDP, the call-home will not be answered by an ACK, but they are essentially the same as it relates to the present method of detection.

In accordance with a further embodiment of the invention, DNS is preferably considered as a remote access method. The inside client device sends a DNS question to a DNS resolver (server) controlled by the adversary. It can be a trivial lookup like www.pleasehackndestroyme.com, where the key is that the adversary owns pleasehackndestroyme.com and controls the authoritative DNS server for the domain (all domain owners do). So, the compromised computer inside the network makes a trivial DNS lookup on some time interval, for example once every minute, once an hour, or once a month. The adversary could overlay an SSH terminal command in the opposite direction over DNS. Since the DNS lookup is not used for learning the IP address of a real webserver, the DNS answer is a 32-bit integer that only looks like an IP address. However, it is possible to configure the DNS answer's 32-bit unsigned integer as actually a command to be run. With the number of domains generating algorithms in use today, it is common to see patterns like fixed length random hostnames as DNS lookups. In this example, the DNS answer is the remote hacker's command inbound to a compromised device in a conventional internal network—and the answer is sent out as an encrypted prefix on a DNS question like tppckxsnfoufbqxkjxje.pleasehackndestroyme.com. So, in normal communications DNS questions elicit DNS answers very fast, like the “da-dum” in a heartbeat. However in this case, a hacker is using the DNS answer as the master command, which triggers an immediate answer as a new DNS question is similar to the familiar datum in a heartbeat. In the world of protocols, there is a natural order in quick responses from the master to the slave device, regardless of protocol. The novel method here, in accordance with this embodiment of the invention, is rather than trying to characterize all remote control covert control methods—the invention instead uses this novel way to detect unnatural stimulus response da-dum heartbeats across all protocols all the time. Once a DNS answered by an IRC is seen, the stimulus response relationship persists throughout the remote control session. This is detectable simply because it does correlate even though it shouldn't, since networks don't normally behave that way. In remote control cases, the actual master is on the server end of a client/server outbound connection from the conventional enclave. This method according to the invention allows remote control sessions to be discovered regardless of whether the inside device is a client, server, or IoT device.

With respect to the above-mentioned “heartbeat”, when a device in a conventional enclave (or a conventional local network) is compromised, it requires a way of calling out to its master. In the previous example, only a very basic call-home method was described, where one or two protocols are used. But in the real world, it is not at all uncommon to see a call-home as seldom as once a year—and for no two call-home occurrences to ever to repeat the same call, resulting in the latter call-home having a different DNS name, target IP, domain name, and different signaling methods than the previous call-home occurrence. Thus, each conventional solution compromised node needs a way to be controlled and a way for the adversary to send commands to the machine, such as a desktop personal computer, as well as a way for the machine to send out the data undetected. In one case studied by the inventors of the inventions disclosed herein, the adversary had registered over 18 million domains just to use for this purpose—so that they may hardly ever need to use the same domain name twice in an operation against any victim. Thus, a variant of this novel method of detecting COVCOM out of a victim's network, in accordance with the invention, is too much novelty. Humans are creatures of habit and have a finite hierarchy of sources of data. Thus, call-homes are specifically not limited to A calling B over and over with a few protocols. This method includes A calling a huge number of seldom or never repeating destinations over any arbitrary set of protocols such that the only logical need being met isn't interested in a well-known host or domain, but instead that A needs to call-home and the adversary being called is more well-funded, such that there is a relatively huge number of destinations that seem unrelated, but are all controlled or capable of being monitored by an adversary.

### EXFIL Detection

Exfiltration is the process of sending out data in a data theft by an adversary. In accordance with a further embodiment of the invention, a method of detecting and stopping exfiltration is provided for the active monitor/controller device in the disclosed security system. This novel method includes splicing every flow into an expected flow and an actual flow, down to the packet and byte levels for all traffic all of the time. If data is being stolen as encrypted prefixes in DNS lookups, the number of distinct DNS FQDNs/hostnames will grow very large with very few repeats over time, which is not normal except in some advertising DGA contexts. Likewise, if data is being transferred in DNS answers, this method of the invention looks for non-repetitive answers as an indicator that this is not a normal hostname to IP address mapping in which a relatively few IP addresses are mirrors of a popular website.

Another feature or aspect of this detection method for exfiltration detection is sneaky back channels or flow reversal. If a customer visits a site that exists for remote backup, a lot of flow from the client to the cloud server may be expected. However, if a customer visits a time and temperature website, small replies of time and temperature may be expected, but never bulk uploading to the time and temp website like it was a remote backup site also. Sneaky back channels, therefore, includes that data flows up and down on a single connection where one direction is unexpected, but hidden as normal protocol acknowledgements when they are instead data EXFIL hidden as ACKs (or other traffic).

In accordance with a further embodiment, automatic detection of slow theft before being cleaned out by a very large number of small data packages, for example, is enabled. In the '058 patent referenced above, a method of recording and accumulating ongoing statistics of the interactions between all devices is disclosed and incorporated in this method. Accordingly, if a hundred thousand remote devices each asked about a single employee at a time, but never asked about the same one—this method catalogs the net effect of coordinated data query attacks.

In accordance with a further embodiment of the invention, EXFIL detection includes counting traffic pushed when pull is expected, and further to add the flows up continually. It is not a normal role for internal devices to push data out of an enterprise and it is suspicious when this data is pushed out via HTTP to a website in volumes greater than data being read from a website. Likewise, there is the issue of control and reputation of the device receiving data from the enterprise. This method combines outflow with reputation of the remote server, where it is located, who owns it, and solves for what flows should be blocked in real-time. As discussed above, the filter information can include the reputation of remote servers, their location and ownership, and so on.

It will be understood that the various inventions, embodiments, features, systems, methods, devices, nodes, networks, and so on, as described above are given by way of example only and are not intended to be an exhaustive list. Software techniques and methods for accurately determining the safety or security of a connection between nodes or devices within a network or outside of the network can be implemented in electronic means, including analog circuitry, digital circuitry, in computer hardware, firmware, software, and/or combinations thereof. The electronic means, including the techniques and methods for operating the monitor/controller as described above, may be implemented in a computer program product tangibly embodied in a machine-readable storage device for execution by a programmable processor; and the above-described methods can be performed by a programmable processor executing a program of instructions to perform functions by operating on input data and generating output. Further electronic means may advantageously be implemented in one or more computer programs that are executable on a programmable system including at least one programmable processor coupled to receive data and instructions from and transmit data and instructions to a data storage system, at least one input device, and at least one output device. Each computer program may be implemented in a high-level procedural or object-oriented programming language, or in assembly or machine language, which can be compiled or interpreted. Suitable processor means include, by way of example, both general and special purpose microprocessors. Generally, a processor receives instructions and data from read-only memory and/or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; optical disks, thumb drives, solid state drives (SSD's) hard drives, and so on. Any of the foregoing may be supplemented by, or incorporated in, specially designed application specific integrated circuits (ASICs) and/or any other suitable platform.

Although particular aspects, features, systems, methods, devices, and so on, have been described in conjunction with the various inventions shown and described herein, it will be understood that other frameworks, configurations, devices, methods, systems, controllers, and other means for monitoring and securing device(s) connected to one or more networks can be provided without departing from the spirit and scope of the invention, so long as each device is shielded from all other devices in an initial no-trust state, including devices within the same network, until the monitor/controller, or the like, determines such devices can communicate and then enables that communication, while monitoring in real-time the device(s), connection(s), and data flow therebetween, to determine if any suspicious activity is taking place, as described above, to thereby prevent connection or enable disconnection between the devices.

It will be understood that the term “preferably” and its derivatives as used throughout the specification refers to one or more exemplary embodiments.

It will be appreciated by those skilled in the art that changes could be made to the embodiments described above without departing from the broad inventive concepts thereof. By way of example, the fields relating to data elements, data structures, tables, blocks, packet streams, threading architecture, and so on, as shown and described, are not limited to a particular order, number and/or size, but may greatly vary without departing from the spirit and scope of the present invention. It will be understood, therefore, that this invention is not limited to the particular embodiments disclosed, but also covers modifications within the spirit and scope of the present invention as defined by the appended claims.

What is claimed is:

1. A method for protecting a network from malicious or unauthorized activity comprising:
assigning a unique identifier to each port from a plurality of ports connected to the same network device;
tagging a data packet transmitted from a given port using the unique identifier associated with the port; and
determining whether to forward the data packet to a destination based at least in part on the unique identifier.

2. The method of claim 1, wherein the unique identifier is a virtual local area network (VLAN) tag.

3. The method of claim 1, wherein the network is a virtual network.

4. The method of claim 3, wherein the data packet is encapsulated with VPN (virtual private network) tunnel information.

5. The method of claim 1, further comprising mapping an IP address and an MAC address to a port via the corresponding unique identifier.

6. The method of claim 5, further comprising logging the MAC address and detecting spoofing based at least in part on a change of the MAC address and the unique identifier.

7. The method of claim 6, wherein the spoofing is detected using a machine learning algorithm trained model.

8. The method of claim 5, further comprising mapping data specific to a device to a port via the corresponding unique identifier and encapsulating the data with the data packet.

9. The method of claim 8, further comprising correlating one or more domains with an entity based at least in part on the data specific to the device.

10. The method of claim 9, further comprising building a reputation for the entity by at least monitoring the data packet.

11. A system for protecting a network from malicious or unauthorized activity, the system comprising:
a controller operably associated with the network and is configured to:
(a) assign a unique identifier to each port from a plurality of ports connected to the same network device;
(b) tag a data packet transmitted from a given port using the unique identifier associated with the port; and
(c) determine whether to forward the data packet to a destination based at least in part on the unique identifier.

12. The system of claim 11, wherein the unique identifier is a virtual local area network (VLAN) tag.

13. The system of claim 11, wherein the network is a virtual network.

14. The system of claim 13, wherein the data packet is encapsulated with VPN (virtual private network) tunnel information.

15. The system of claim 11, wherein the controller is further configured to map an IP address and an MAC address to a port via the corresponding unique identifier.

16. The system of claim 15, wherein the controller is further configured to log the MAC address and detect spoofing based at least in part on a change of the MAC address and the unique identifier.

17. The system of claim 16, wherein the spoofing is detected using a machine learning algorithm trained model.

18. The system of claim 15, wherein the controller is further configured to map data specific to a device to a port via the corresponding unique identifier and encapsulate the data with the data packet.

19. The system of claim 18, wherein the controller is further configured to correlate one or more domains with an entity based at least in part on the data specific to the device.

20. The system of claim 19, wherein the controller is further configured to build a reputation for the entity by at least monitoring the data packet.
